(19) United States
(12) Patent Application Publication
(10) Pub. No.: US 2026/0176554 A1
(43) Pub. Date: Jun. 25, 2026

(54) TREATMENT LIQUID, TREATMENT METHOD FOR OBJECT TO BE TREATED, TREATMENT METHOD OF PAD, AND MANUFACTURING METHOD OF ELECTRONIC DEVICE

(71) Applicant: FUJIFILM Corporation, Tokyo (JP)

(72) Inventors: Shimpei YAMADA, Shizuoka (JP); Tetsuya KAMIMURA, Shizuoka (JP); Daiyo MIURA, Shizuoka (JP)

(73) Assignee: FUJIFILM Corporation, Tokyo (JP)

(21) Appl. No.: 19/545,336

(22) Filed: Feb. 20, 2026

Related U.S. Application Data
(63) Continuation of application No. PCT/JP2024/030942, filed on Aug. 29, 2024.

(30) Foreign Application Priority Data
Sep. 27, 2023 (JP) 2023-165258
Mar. 18, 2024 (JP) 2024-042066

(51) Int. Cl. C11D 1/40; C11D 3/00; C11D 3/20; C11D 3/22; C11D 3/30; C11D 3/33; C11D 3/36; C11D 3/37

(52) U.S. Cl. CPC C11D 1/40; C11D 3/0005; C11D 3/2034; C11D 3/2079; C11D 3/2086; C11D 3/222; C11D 3/30; C11D 3/33; C11D 3/361; C11D 3/3765; C11D 3/378

(57) ABSTRACT

An object of the present invention is to provide a treatment liquid which can suppress corrosion of tungsten or molybdenum, has excellent organic residue removability, and further has excellent iron oxide residue removability. The treatment liquid of the present invention contains a specific compound represented by Formula (1), and at least one phosphonic acid compound selected from the group consisting of phosphonic acid and an organic phosphonic acid, in which a mass ratio of a content of the specific compound to a content of the phosphonic acid compound is 0.001 to 20.0.

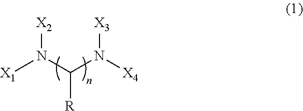

### CROSS-REFERENCE TO RELATED APPLICATIONS

This application is a Continuation of PCT International Application No. PCT/JP2024/030942 filed on Aug. 29, 2024, which claims priority under 35 U.S.C. § 119(a) to Japanese Patent Application No. 2023-165258 filed on Sep. 27, 2023 and Japanese Patent Application No. 2024-042066 filed on Mar. 18, 2024. The above applications are hereby expressly incorporated by reference, in their entirety, into the present application.

### BACKGROUND OF THE INVENTION

### 1. Field of the Invention

The present invention relates to a treatment liquid, a treatment method for an object to be treated, a treatment method for a pad, and a manufacturing method of an electronic device.

### 2. Description of the Related Art

In the field of semiconductors, with remarkable increase in integration and performance, even a very small amount of impurities (contaminants) and/or attachments (particles) has a great influence on the performance of an apparatus and eventually the yield of a product.

In each manufacturing step of a semiconductor element, various contaminants and particles (hereinafter, also referred to as residues) may be generated. In the manufacture of the semiconductor, in order to remove such residues, a treatment step of a substrate is appropriately performed.

For example, in manufacturing of the semiconductor element, a chemical mechanical polishing (CMP) treatment in which a surface of a semiconductor substrate having a metal wire film, a barrier metal, an insulating film, or the like is flattened using a polishing slurry containing abrasive particles (for example, silica and alumina) or the like may be carried out.

In the CMP treatment, the abrasive particles to be used in the CMP treatment, a polished wiring line metal film, and/or a metal component derived from the barrier metal or the like easily remain on the surface of the semiconductor substrate after polishing and on a member used in the polishing (for example, a polishing pad). Therefore, after the CMP treatment, a step of removing these residues using a treatment liquid is generally performed.

As described above, in a semiconductor manufacturing process, the treatment liquid is used for treatments such as removal of unnecessary metal-containing substances, resist, and residues of various members used for manufacturing the semiconductor.

As the treatment liquid described above, for example, JP2010-515246A discloses an aqueous cleaning composition for cleaning a residue after plasma etching, the composition containing an etchant, water, a low-permittivity passivation agent, a surfactant, and a silica source, and including predetermined component (I), (II), or (III).

### SUMMARY OF THE INVENTION

As a result of studying the composition specifically disclosed in JP2010-515246A, the present inventors have found that it is not possible to achieve corrosion inhibition properties of tungsten or molybdenum, organic residue removability, and iron oxide residue removability at a desired level, and there is room for improvement.

Therefore, an object of the present invention is to provide a treatment liquid which can suppress corrosion of tungsten or molybdenum, has excellent organic residue removability, and further has excellent iron oxide residue removability.

Another object of the present invention is to provide a treatment method for an object to be treated, a treatment method for a pad, and a manufacturing method of an electronic device, using the above-described treatment liquid.

As a result of conducting an extensive investigation to achieve the objects, the present inventors have found that the objects can be achieved by the following constitution.

[1] A treatment liquid comprising:
a specific compound represented by Formula (1) described later; and
at least one phosphonic acid compound selected from the group consisting of phosphonic acid and an organic phosphonic acid,
in which a mass ratio of a content of the specific compound to a content of the phosphonic acid compound is 0.001 to 20.0.

[2] The treatment liquid according to [1],
in which a log D value of the specific compound at a pH of 7.4 is −7.2 to −1.0.

[3] The treatment liquid according to [1] or [2],
in which a pH is 3.0 to 9.0.

[4] The treatment liquid according to any one of [1] to [3], further comprising:
at least one basic amino acid selected from the group consisting of arginine, histidine, and lysine.

[5] The treatment liquid according to any one of [1] to [4], further comprising:
cyclodextrin or a cyclodextrin derivative.

[6] The treatment liquid according to [4],
in which a mass ratio of the content of the specific compound to a content of the basic amino acid is 0.2 to 10.0.

[7] The treatment liquid according to any one of [1] to [6],
in which the specific compound contains 2 or 3 nitrogen atoms.

[8] The treatment liquid according to any one of [1] to [7],
in which the specific compound contains 3 to 11 carbon atoms.

[9] The treatment liquid according to any one of [1] to [8], further comprising:
an antibacterial agent.

[10] The treatment liquid according to any one of [1] to [9], further comprising:
an anionic polymer.

[11] The treatment liquid according to any one of [1] to [10], further comprising:
a low-molecular-weight organic acid different from the phosphonic acid compound.

[12]A treatment method for an object to be treated, comprising:
a step of bringing an object to be treated containing at least one of tungsten or molybdenum, which has been subjected to a chemical mechanical polishing treatment, into contact with the treatment liquid according to any one of [1] to [11].

[13]A treatment method for a pad, comprising:
a step of bringing a pad used for chemical mechanical polishing into contact with the treatment liquid according to any one of [1] to [11].

[14]A manufacturing method of an electronic device, comprising:
the treatment method for an object to be treated according to [12].

According to the present invention, it is possible to provide a treatment liquid which can suppress corrosion of tungsten or molybdenum, has excellent organic residue removability, and further has excellent iron oxide residue removability.

In addition, according to the present invention, it is possible to provide a treatment method for an object to be treated, a treatment method for a pad, and a manufacturing method of an electronic device, using the above-described treatment liquid.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

In the present specification, numerical ranges represented by “to” include numerical values before and after “to” as lower limit values and upper limit values.

In addition, in the present specification, in a case where there are two or more components corresponding to a certain component, “content” of such a component means the total content of the two or more components.

In the present specification, regarding numerical ranges that are described stepwise, an upper limit value or a lower limit value described in a numerical range may be replaced with an upper limit value or a lower limit value of another stepwise numerical range. In addition, regarding the numerical range described in the present specification, an upper limit value or a lower limit value described in a numerical value may be replaced with a value described in Examples.

In the present specification, a combination of two or more preferred aspects is a more preferred aspect.

In the present specification, “total mass of components in the treatment liquid excluding a solvent” means the total mass of all components contained in the treatment liquid, other than a solvent such as water and an organic solvent.

Unless otherwise specified, compounds described in the present specification may include structural isomers, optical isomers, and isotopes. In addition, one kind of structural isomer, optical isomer, and isotope may be included, or two or more kinds thereof may be included.

In the present specification, in a case of a plurality of substituents, linking groups, and the like (hereinafter, referred to as a substituent and the like) represented by specific reference numeral, or in a case of simultaneously defining a plurality of the substituent and the like, it means that each of the substituent and the like may be the same as or different from each other. The same applies to the definition of the number of substituents and the like.

A bonding direction of divalent groups cited in the present specification is not limited unless otherwise specified. For example, in a case where Y in a compound represented by Formula “X—Y—Z” is —COO—, Y may be —CO—O— or —O—CO—. In addition, the above-described compound may be “X—CO—O—Z” or “X—O—CO—Z”.

In the present specification, “ppm” means “parts-per-million (10⁻⁶)”, and “ppb” means “parts-per-billion (10⁻⁹)”.

In the present specification, “weight-average molecular weight” means a weight-average molecular weight in terms of polyethylene glycol measured by gel permeation chromatography (GPC).

In the present specification, “(meth)acrylic acid” is a concept including both acrylic acid and methacrylic acid, and “(meth)acrylamide” is a concept including both acrylamide and methacrylamide.

### [Treatment Liquid]

Hereinafter, the treatment liquid will be described in detail.

The treatment liquid according to the embodiment of the present invention (hereinafter, also simply referred to as “treatment liquid”) contains a specific compound represented by Formula (1) described later, and at least one phosphonic acid compound selected from the group consisting of phosphonic acid and an organic phosphonic acid, in which a mass ratio of a content of the specific compound to a content of the phosphonic acid compound is 0.001 to 20.0.

The reason why the treatment liquid having the above-described configuration can achieve the object of the present invention is not necessarily clear, but the present inventors speculate as follows.

The mechanism by which the effect is obtained is not limited by the following supposition. In other words, even in a case where an effect is obtained by a mechanism other than the following, it is included in the scope of the present invention.

The specific compound having a predetermined structure has excellent removability of an oxide film formed on a surface of tungsten and molybdenum and an iron oxide residue adhered to the surface, and can efficiently remove an organic residue, an iron oxide residue, and an oxide film on which the residue is adhered. Here, the compound exhibiting the removability of the organic residue and the oxide film may easily corrode tungsten and molybdenum, but the specific compound also has low corrosiveness to tungsten and molybdenum. Furthermore, the phosphonic acid compound selectively coordinates to the iron oxide residue to exhibit excellent iron oxide residue removability. It is considered that the treatment liquid can achieve both excellent corrosion inhibition properties of tungsten and molybdenum, excellent organic residue removability, and excellent iron oxide residue removability by containing the specific compound and the phosphonic acid compound described above at a predetermined ratio.

Hereinafter, the characteristic that can suppress the corrosion of tungsten or molybdenum is also simply referred to as “corrosion inhibition properties”, and the fact that at least one of the corrosion inhibition properties, the organic residue removability, or the iron oxide residue removability is more excellent is also referred to as “effect of the present invention is more excellent”.

Hereinafter, each component contained in the treatment liquid and physical properties of the treatment liquid will be described in detail.

### [Compound Represented by Formula (1) (Specific Compound)]

The treatment liquid contains a specific compound represented by Formula (1) (also simply referred to as “specific compound”).

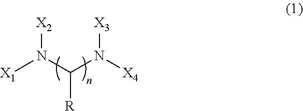

In Formula (1), X₁ to X₄ and R each independently represent a hydrogen atom or an aliphatic hydrocarbon group which may have a hydroxyl group or an amino group.

The above-described aliphatic hydrocarbon group may be linear, branched, or cyclic, and is preferably linear or branched, and more preferably linear.

Examples of the above-described aliphatic hydrocarbon group include an alkyl group, an alkenyl group, and an alkynyl group, and an alkyl group is preferable.

From the viewpoint that the effect of the present invention is more excellent, the number of carbon atoms in the above-described aliphatic hydrocarbon group which may have a hydroxyl group or an amino group is preferably 1 to 12, more preferably 1 to 6, and still more preferably 1 to 3. In a case where the aliphatic hydrocarbon group has an amino group, the number of carbon atoms in the aliphatic hydrocarbon group having an amino group includes the number of carbon atoms in the amino group. For example, the number of carbon atoms in a 2-(dimethylamino)ethyl group is 4.

In a case where the aliphatic hydrocarbon group has a hydroxyl group or an amino group, the number thereof is preferably 1 to 3 and more preferably 1.

The amino group which may be included in the above-described aliphatic hydrocarbon group may be any of a primary amino group (—NH₂), a secondary amino group (—NR^{N}H), or a tertiary amino group (—NR^{N}₂), and from the viewpoint that the effect of the present invention is more excellent, it is preferably a primary amino group or a secondary amino group, and more preferably a primary amino group.

R^{N}'s each independently represent a hydrocarbon group which may have a hydroxyl group.

Examples of the hydrocarbon group represented by R^{N} include an aliphatic hydrocarbon group and an aromatic hydrocarbon group, and an aliphatic hydrocarbon group is preferable, and an alkyl group is more preferable.

The number of carbon atoms in the hydrocarbon group represented by R^{N} is preferably 1 to 6, more preferably 1 to 3, and still more preferably 1.

X₁ to X₄ are preferably a hydrogen atom or an aliphatic hydrocarbon group having 1 to 6 carbon atoms, which may have a hydroxyl group or an amino group, and more preferably a hydrogen atom or an aliphatic hydrocarbon group having 1 to 3 carbon atoms, which may have a hydroxyl group or an amino group.

R is preferably a hydrogen atom or an alkyl group, and more preferably a hydrogen atom or an alkyl group having 1 to 3 carbon atoms.

As described above, a plurality of R's may be the same or different from each other.

A plurality of R's may be bonded to each other to form a ring. Examples of the ring formed by bonding a plurality of R's to each other include an aliphatic hydrocarbon ring and a nitrogen-containing aliphatic ring, and an aliphatic hydrocarbon ring is preferable and a cycloalkane is more preferable.

The above-described ring is preferably a ring formed by bonding two R's to each other.

The number of ring members in the ring is preferably 3 to 8 and more preferably 3 to 6.

n represents an integer of 2 or more, and is preferably an integer of 2 to 8, more preferably an integer of 2 to 6, and still more preferably 2 or 3.

From the viewpoint that the effect of the present invention is more excellent, in a case where n is 2, it is preferable that at least one of X₁ to X₄ or R represents an aliphatic hydrocarbon group which may have a hydroxyl group or an amino group. In other words, it is preferable that the specific compound is a compound different from ethylenediamine.

A molecular weight of the specific compound is preferably 60 to 290, more preferably 70 to 230, and still more preferably 80 to 180.

The number of nitrogen atoms in the specific compound is 2 or more, and from the viewpoint that the effect of the present invention is more excellent, it is preferably 2 to 4 and more preferably 2 or 3.

The number of carbon atoms in the specific compound is 2 or more, and from the viewpoint that the effect of the present invention is more excellent, it is preferably 3 to 18, more preferably 3 to 11, still more preferably 3 to 9, and particularly preferably 3 to 7.

A log D value of the specific compound at a pH of 7.4 is preferably −7.2 to −1.0 and more preferably −6.0 to −2.0.

The log D value at a pH of 7.4 is a value of a logarithm of an octanol/water partition coefficient in which dissociation due to pH at a pH of 7.4 is taken into consideration. As the log D value at a pH of 7.4, a value (ACD/log D) described in compound database ChemSpider (http://www.chemspider.com/) is adopted. In a case where the above log D value is not described, a value calculated by using an ACD/log D module of software of ACD/Percepta platform of Advanced Chemistry Development Inc. may be adopted.

Examples of the specific compound include ethylenediamine (EDA), 1,3-propanediamine (13PDA), N-ethylethylenediamine (EEDA), 1,2-propanediamine (12PDA), N,N,N′,N′-tetrakis(2-hydroxyethyl)ethylenediamine (TK2HEEDA), N,N,N′,N″,N′″,N′″-hexamethyltriethylenetetramine (HMTEEA), 1,3-diaminopentane (13DAP), N-(3-aminopropyl)diethanolamine (3APDEA), 3-(dibutylamino)propylamine (3DBAPA), bis(2-aminoethyl)amine (B2AEA), N,N,N′,N″,N″-pentamethyldiethylenetriamine (PMDETA), tris(2-aminoethyl)amine (T2AEA), N,N′-bis(3-aminopropyl)ethylenediamine (BAPEDA), bis(3-aminopropyl)amine (BAPA), tris(3-aminopropyl)amine (T3APA), 2,2-dimethyl-1,3-propanediamine, 2,2′-diamino-N-methyldiethylamine, 2-[(3-aminopropyl)amino]ethanol, 3,3′-diamino-N-methyldipropylamine, N,N-diethyl-1,3-propanediamine, and 1,4-cyclohexanediamine.

Among these, EEDA, 13PDA, 12PDA, 3APDEA, B2AEA, BAPA, TK2HEEDA, 3DBAPA, BAPEDA, T3APA, or T2AEA is preferable; EEDA, 13PDA, 12PDA, 3APDEA, B2AEA, BAPA, TK2HEEDA, or 3DBAPA is more preferable; and EEDA, 13PDA, 12PDA, 3APDEA, B2AEA, or BAPA is still more preferable.

The specific compound may be used alone, or two or more types thereof may be used in combination.

A content of the specific compound is preferably 0.00005% to 10.0% by mass, more preferably 0.0001% to 1.0% by mass, and still more preferably 0.002% to 0.1% by mass with respect to the total mass of the treatment liquid.

From the viewpoint that the organic residue removability and the corrosion inhibition properties were more excellent, the content of the specific compound is preferably 0.1% to 95.0% by mass, more preferably 1.0% to 90.0% by mass, and still more preferably 10.0% to 40.0% by mass with respect to the total mass of components in the treatment liquid excluding a solvent.

### [Phosphonic Acid Compound]

The treatment liquid contains at least one phosphonic acid compound selected from the group consisting of phosphonic acid (HPO₃H₂) and an organic phosphonic acid.

The phosphonic acid compound may be ionized in the treatment liquid or may be in a salt form. Examples of the above-described salt include a metal salt (for example, an alkali metal salt and an alkaline earth metal salt) and an ammonium salt (for example, a salt with an ammonium ion and a salt with a quaternary ammonium cation).

As the phosphonic acid compound, an organic phosphonic acid is preferable. The organic phosphonic acid is a compound including one or more phosphonic acid groups and one or more carbon atoms. In the present specification, in a case of including a phosphonic acid group, an aspect in which the phosphonic acid group is included as a part of a phosphoric acid group (—O—PO₃H₂) is not intended.

The number of phosphonic acid groups in the organic phosphonic acid is not particularly limited as long as it is 1 or more, and is preferably 1 to 8 and more preferably 1 to 6.

The organic phosphonic acid may have a substituent other than the phosphonic acid group. Examples of the substituent other than the phosphonic acid group include an amino group, a carboxylic acid group, a sulfonic acid group, and a hydroxyl group.

The number of carbon atoms in the organic phosphonic acid is 1 or more, and is preferably 1 to 20, more preferably 1 to 12, and still more preferably 1 to 8.

Examples of the organic phosphonic acid include a compound represented by Formula (P1).

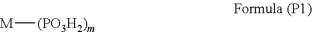

In Formula (P1), M represents an m-valent linking group. m represents an integer of 1 or more.

Examples of the above-described m-valent linking group include an m-valent hydrocarbon group in which one or more methylene groups may be replaced with any of an oxygen atom, a sulfur atom, —CO—, or —NR^{T}—, which may have a substituent. R^{T}'s each independently represent a hydrogen atom or a hydrocarbon group which may have a substituent.

The above-described m-valent linking group may be linear, branched, or cyclic.

The above-described hydrocarbon group may be an aliphatic hydrocarbon group or an aromatic hydrocarbon group, and is preferably an aliphatic hydrocarbon group.

Examples of the substituent which may be included in the above-described m-valent hydrocarbon group include an amino group, a carboxylic acid group, a sulfonic acid group, and a hydroxyl group.

The number of carbon atoms in the above-described m-valent hydrocarbon group is preferably 1 to 20, more preferably 1 to 12, and still more preferably 1 to 8.

As the above-described m-valent linking group, an m-valent aliphatic hydrocarbon group in which one or more methylene groups may be replaced with —NR^{T}— and which may have a substituent is preferable.

m represents an integer of 1 or more, and it is preferably 1 to 8 and more preferably 1 to 6.

Examples of the phosphonic acid compound include phosphonic acid, 1-hydroxyethylidene-1,1-diphosphonic acid (HEDPO), ethylenediaminetetramethylenephosphonic acid (EDTMP), diethylenetriaminepentakis(methylphosphonic acid) (DTPMP), nitrilotris(methylenephosphonic acid) (NMIPA), phytic acid, 2-phosphonobutane-1,2,4-tricarboxylic acid (PBTCA), iminodi(methylenephosphonic acid) (IDMP), ethylaminebis(methylenephosphonic acid) (EABMP), methylaminebis(methylenephosphonic acid) (MADP), N,N-dimethylaminomethylphosphonic acid (DAMP), hydroxymethylphosphonic acid (HMP), aminomethylphosphonic acid (AMPA), methylphosphonic acid (MP), ethylidenediphosphonic acid, 1-hydroxypropylidene-1,1′-diphosphonic acid, 1-hydroxybutylidene-1,1′-diphosphonic acid, dodecylaminobis(methylenephosphonic acid), 1,3-propylenediaminebis(methylenephosphonic acid), ethylenediaminebis(methylenephosphonic acid) (EDDPO), ethylenediaminetetra(ethylenephosphonic acid), 1,3-propylenediaminetetra(methylenephosphonic acid) (PDTMP), 1,2-diaminopropanetetra(methylenephosphonic acid), 1,6-hexamethylenediaminetetra(methylenephosphonic acid), diethylenetriaminepenta(methylenephosphonic acid) (DEPPO), diethylenetriaminepenta(ethylenephosphonic acid), triethylenetetraminehexa(methylenephosphonic acid), and triethylenetetraminehexa(ethylenephosphonic acid).

In addition, as the phosphonic acid compound, compounds described in paragraphs [0026] to [0036] of WO2018/020878A can also be used.

Among these, HEDPO, EDTMP, DTPMP, NMPA, phytic acid, PBTCA, IDMP, EABMP, MADP, DAMP, HMP, AMPA, or MP is preferable as the phosphonic acid compound.

The phosphonic acid compound may be used alone or in combination of two or more thereof.

From the viewpoint that the effect of the present invention is more excellent, a content of the phosphonic acid compound is preferably 0.0001% to 40.0% by mass, more preferably 0.0005% to 10.0% by mass, and still more preferably 0.01% to 1.0% by mass with respect to the total mass of the treatment liquid.

From the viewpoint that the effect of the present invention is more excellent, the content of the phosphonic acid compound is preferably 4.0% to 99.9% by mass, more preferably 10.0% to 95.0% by mass, and still more preferably 40.0% to 90.0% by mass with respect to the total mass of components in the treatment liquid excluding a solvent.

A mass ratio of the content of the specific compound to the content of the phosphonic acid compound is 0.001 to 20.0 (0.0010 to 20.0), and from the viewpoint that the effect of the present invention is more excellent, it is preferably 0.01 to 10.0 and more preferably 0.1 to 1.0.

In a case where the mass ratio of the content of the specific compound to the content of the phosphonic acid compound is less than 0.001, it is not preferable in terms of the organic residue removability; and in a case where the mass ratio is more than 20.0, it is not preferable in terms of the corrosion inhibition properties and the iron oxide residue removability.

### [Basic Amino Acid]

From the viewpoint that the corrosion inhibition properties are more excellent, it is preferable that the treatment liquid also contains a basic amino acid. By adsorbing and protecting the basic amino acid capable of having a positive charge on the surface of tungsten or molybdenum, the corrosion of tungsten or molybdenum can be further suppressed.

Examples of the basic amino acid include arginine, histidine, lysine, ornithine, 2,4-diaminobutyric acid, tryptophan, asparagine, and glutamine.

The treatment liquid preferably contains at least one selected from the group consisting of arginine, histidine, and lysine as the basic amino acid.

The above-described basic amino acid may be any of a D form, an L form, or a DL form.

The basic amino acid may be used alone, or two or more types thereof may be used in combination.

A content of the basic amino acid is preferably 0.0001% to 5.0% by mass, more preferably 0.001% to 1.0% by mass, and still more preferably 0.001% to 0.01% by mass with respect to the total mass of the treatment liquid.

From the viewpoint that the effect of the present invention is more excellent, a content of the basic amino acid is preferably 1.0% to 60.0% by mass, more preferably 3.0% to 30.0% by mass, and still more preferably 3.0% to 10.0% by mass with respect to the total mass of components in the treatment liquid excluding a solvent.

A mass ratio of the content of the specific compound to the content of the basic amino acid is preferably 0.05 to 30.0, more preferably 0.2 to 10.0, and still more preferably 0.2 to 5.0.

### [Cyclodextrin or Cyclodextrin Derivative]

From the viewpoint that the organic residue removability is more excellent, the treatment liquid preferably contains cyclodextrin or a cyclodextrin derivative, and more preferably contains cyclodextrin. By containing cyclodextrin capable of encapsulating hydrophobic organic residues, the organic residue removability is more excellent.

Cyclodextrin is one kind of cyclic oligosaccharide having a cyclic structure in which a plurality of D-glucoses are bonded by a glucoside bond. The number of glucoses bonded is usually 5 or more, and is more usually 6 to 8.

Examples of the cyclodextrin include α-cyclodextrin, β-cyclodextrin, and γ-cyclodextrin.

Examples of the cyclodextrin derivative include a compound in which at least one or more hydrogen atoms of hydroxyl groups in cyclodextrin are substituted with a substituent (for example, an alkyl group and an acyl group); and specific examples thereof include 2-hydroxypropyl-cyclodextrin and 2-hydroxyethyl-cyclodextrin.

The cyclodextrin or the cyclodextrin derivative may be used alone or in combination of two or more kinds thereof.

A content of the cyclodextrin or the cyclodextrin derivative is preferably 0.0001% to 5.0% by mass and more preferably 0.001% to 0.05% by mass with respect to the total mass of the treatment liquid.

The content of the cyclodextrin or the cyclodextrin derivative is preferably 10.0% to 60.0% by mass and more preferably 25.0% to 50.0% by mass with respect to the total mass of components in the treatment liquid excluding a solvent.

### [Antibacterial Agent]

The treatment liquid preferably further contains an antibacterial agent.

The antibacterial agent is a compound having an antibacterial action against bacteria and/or an antifungal action against molds, and is a compound different from the various components described above and various components described later.

The antibacterial agent may have a form of a salt (for example, a known salt).

Examples of the antibacterial agent include a quaternary ammonium-based antibacterial agent, a carboxylic acid-based antibacterial agent, a phenol-based antibacterial agent, a biguanide-based antibacterial agent, a sulfonamide-based antibacterial agent, a peroxide-based antibacterial agent, an isothiazolinone-based antibacterial agent, an imidazole-based antibacterial agent, an ester-based antibacterial agent, an alcohol-based antibacterial agent, a carbamate-based antibacterial agent, an iodine-based antibacterial agent, and antibiotics.

The quaternary ammonium-based antibacterial agent refers to a compound having an antibacterial action and/or an antifungal action, among compounds which have at least one quaternary ammonium cationic group in the molecule, and salts thereof.

Examples of the quaternary ammonium-based antibacterial agent include benzalkonium chloride, didecyldimethylammonium chloride (DDAC), hexadecylpyridinium chloride (CPC), 3,3′-(2,7-dioxaoctane)bis(1-dodecylpyridinium bromide) (Hyjeria), benzethonium chloride, and domiphen bromide. Among these, benzethonium chloride is preferable.

Examples of the carboxylic acid-based antibacterial agent include unsaturated carboxylic acids such as sorbic acid (hexadienoic acid) and dehydroacetic acid, and aromatic carboxylic acids such as benzoic acid and salicylic acid. Among these, sorbic acid, dehydroacetic acid, or benzoic acid is preferable, sorbic acid or dehydroacetic acid is more preferable, and sorbic acid is still more preferable.

Examples of the phenol-based antibacterial agent include 3-methyl-4-chlorophenol (PCMC), 3-methyl-4-isopropylphenol (BIOSOL), 4-chloro-3,5-dimethylphenol (PCMX), cresol, chlorothymol, dichloroxylenol, and hexachlorophene. Among these, cresol is preferable.

Examples of the biguanide-based antibacterial agent include bis(p-chlorophenyldiguanide)hexanedigluconate (chlorhexidine gluconate) and poly(hexamethylene biguanide) hydrochloride (hexamethylene biguanidine hydrochloride). Among these, chlorhexidine gluconate is preferable.

Examples of the sulfonamide-based antibacterial agent include N-dichlorofluoromethylthio-N′,N′-dimethyl-N-phenylsulfamide (dichlorfluoramide) and N-dichlorofluoromethylthio-N′,N′-dimethyl-N-p-tolylsulfamide (tolylfluanide). Among these, tolylfluanid is preferable.

Examples of the peroxide-based antibacterial agent include hydrogen peroxide, peracetic acid, and chlorine dioxide. Among these, peracetic acid is preferable.

Examples of the isothiazolinone-based antibacterial agent include 2-methyl-4-isothiazolin-3-one (MIT), 2-octyl-4-isothiazolin-3-one (OIT), 1,2-benzisothiazol-3(2H)-one (BIT), and 5-chloro-2-methyl-4-isothiazolin-3-one (CIT). Among these, MIT, OIT, or BIT is preferable, and MIT or OIT is more preferable.

Examples of the imidazole-based antibacterial agent include 2-(4-thiazolyl)-benzimidazole (TBZ) and methyl 2-benzimidazolecarbamate (PREVENTOL BCM).

Examples of the ester-based antibacterial agent include glycerol laurate (monoglyceride) and a parahydroxybenzoic acid ethyl ester (ethylparaben).

Examples of the alcohol-based antibacterial agent include ethyl alcohol (ethanol), 2-propanol (IPA), phenoxyethanol, 1,2-pentanediol, and 1,2-hexanediol.

Examples of the carbamate-based antibacterial agent include 3-iodo-2-propynyl butyl carbamate (GLYCASIL).

Examples of the iodine-based antibacterial agent include [(4-chlorophenoxy)methyl]-3-iodo-2-propynyl ether (IF1000).

As the antibacterial agent, a quaternary ammonium-based antibacterial agent, a carboxylic acid-based antibacterial agent, a phenol-based antibacterial agent, or an isothiazolinone-based antibacterial agent is preferable, and a carboxylic acid-based antibacterial agent or an isothiazolinone-based antibacterial agent is more preferable.

Among these, as the antibacterial agent, benzethonium chloride, sorbic acid, dehydroacetic acid, benzoic acid, salicylic acid, cresol, MIT, OIT, or BIT is preferable.

The antibacterial agent may be used alone, or two or more types thereof may be used in combination.

A content of the antibacterial agent is preferably 0.00001% to 2.0% by mass and more preferably 0.0001% to 0.1% by mass with respect to the total mass of the treatment liquid.

In addition, the content of the antibacterial agent is preferably 0.01% to 10.0% by mass and more preferably 0.1% to 5.0% by mass with respect to the total mass of components in the treatment liquid excluding a solvent.

### [Low-Molecular-Weight Organic Acid]

From the viewpoint that the iron oxide residue removability is more excellent, it is preferable that the treatment liquid further contains a low-molecular-weight organic acid different from the above-described phosphonic acid compound. The above-described low-molecular-weight organic acid is intended to be a component different from the above-described basic amino acid.

The low-molecular-weight organic acid refers to an organic acid having a molecular weight of 700 or less.

The molecular weight of the low-molecular-weight organic acid is preferably 600 or less, more preferably 450 or less, and still more preferably 300 or less. The lower limit of the above-described molecular weight is preferably 50 or more, and more preferably 100 or more.

The number of carbon atoms in the low-molecular-weight organic acid is preferably 2 to 15.

Examples of the low-molecular-weight organic acid include a carboxylic acid-based organic acid and a sulfonic acid-based organic acid, and a carboxylic acid-based organic acid is preferable.

The carboxylic acid-based organic acid is preferably an aliphatic carboxylic acid and more preferably a saturated aliphatic carboxylic acid. In other words, the carboxylic acid-based organic acid is preferably a compound different from an aromatic carboxylic acid, and it is also preferable that the carboxylic acid-based organic acid does not have a carbon-carbon unsaturated bond.

The number of carboxylic acid groups in the carboxylic acid-based organic acid is 1 or more, preferably 2 or more. The upper limit thereof is not particularly limited, but may be 8 or less.

Examples of the aliphatic carboxylic acid include a polycarboxylic acid, a hydroxycarboxylic acid, and an amino polycarboxylic acid; and a polycarboxylic acid or a hydroxycarboxylic acid is preferable and a polycarboxylic acid is more preferable.

Examples of the polycarboxylic acid include tartaric acid, citric acid, malonic acid, succinic acid, malic acid, oxalic acid, glutaric acid, adipic acid, pimelic acid, sebacic acid, maleic acid, and isocitric acid.

Examples of the hydroxycarboxylic acid include gluconic acid, glycolic acid, lactic acid, heptonic acid, glyceric acid, and hydroxybutyric acid.

Examples of the amino polycarboxylic acid include 1,4-butanediaminetetraacetic acid (BDTA), diethylenetriaminepentaacetic acid (DTPA), ethylenediaminetetrapropionic acid, triethylenetetraminehexaacetic acid, 1,3-diamino-2-hydroxypropane-N,N,N′,N′-tetraacetic acid, 1,3-propanediamine-N,N,N′,N′-tetraacetic acid, ethylenediaminetetraacetic acid (EDTA), trans-1,2-diaminocyclohexanetetraacetic acid, ethylenediaminediacetic acid, ethylenediaminedipropionic acid, 1,6-hexamethylenediamine-N,N,N′,N′-tetraacetic acid, N,N-bis(2-hydroxybenzyl)ethylenediamine-N,N-diacetic acid, diaminopropanetetraacetic acid, 1,4,7,10-tetraazacyclododecane-tetraacetic acid, diaminopropanoltetraacetic acid, (hydroxyethyl)ethylenediaminetriacetic acid, and iminodiacetic acid (IDA).

Among these, tartaric acid, citric acid, malonic acid, succinic acid, or malic acid is preferable as the low-molecular-weight organic acid.

The low-molecular-weight organic acid may be used alone, or two or more types thereof may be used in combination.

A content of the low-molecular-weight organic acid is preferably 0.0001% to 3.0% by mass and more preferably 0.001% to 1.0% by mass with respect to the total mass of the treatment liquid.

In addition, the content of the low-molecular-weight organic acid is preferably 0.1% to 20.0% by mass and more preferably 1.0% to 10.0% by mass with respect to the total mass of components in the treatment liquid excluding a solvent.

### [Water]

It is preferable that the treatment liquid contains water.

The type of the water may be any type of water as long as it does not adversely affect the semiconductor substrate; and distilled water, deionized (DI) water, or pure water (ultrapure water) can be used. The pure water (ultrapure water) is preferable from the viewpoint that it contains almost no impurities and has less influence on a semiconductor substrate in a step of manufacturing the semiconductor substrate.

A content of water may be a remainder of components which can be contained in the treatment liquid.

The content of the water is preferably 60.0% by mass or more, more preferably 80.0% by mass or more, still more preferably 90.0% by mass or more, and particularly preferably 97.0% by mass or more with respect to the total mass of the treatment liquid. From the viewpoint that the effect of the present invention is more excellent, the upper limit thereof is preferably 99.99% by mass or less, and more preferably 99.9% by mass or less.

### [Other Components]

The treatment liquid may contain other components in addition to the above-described components. Examples of the other components include a polymer, a surfactant, a pH adjusting agent, an anticorrosion agent, an organic solvent, a polyhydroxy compound having a molecular weight of 500 or more, an oxidizing agent, a reducing agent, and a fluoride.

### <Polymer>

From the viewpoint that the organic residue removability is more excellent, the treatment liquid also preferably contains a polymer.

The polymer is preferably a water-soluble polymer.

The “water-soluble polymer” means a compound having two or more constitutional units linked in a linear or mesh form through a covalent bond, in which a mass of the polymer dissolved in 100 g of water at 20° C. is 0.1 g or more.

More specific examples of the water-soluble polymer include anionic polymers such as poly(meth)acrylic acid, polysulfonic acid, and a copolymer thereof (for example, an acrylic acid-sulfonic acid copolymer), poly(meth)acrylamide, polyvinyl alcohol, hydroxyethyl cellulose, and polyvinylpyrrolidone.

As the water-soluble polymer, an anionic polymer is preferable, poly(meth)acrylic acid, polysulfonic acid, or a copolymer thereof is preferable, and poly(meth)acrylic acid or polysulfonic acid is more preferable. All or a part of the anionic groups in the above-described anionic polymer may form a salt.

A weight-average molecular weight (Mw) of the water-soluble polymer is preferably 1,000 or more, and more preferably 2,000 or more. The upper limit of the weight-average molecular weight (Mw) of the water-soluble polymer is usually 1,500,000 or less, and is preferably 1,200,000 or less and more preferably 1,000,000 or less. The weight-average molecular weight of the water-soluble polymer is a value in terms of polyethylene glycol measured by gel permeation chromatography (GPC).

A content of the polymer is preferably 0.0001% to 5.0% by mass and more preferably 0.001% to 0.1% by mass with respect to the total mass of the treatment liquid.

The content of the polymer is preferably 1.0% to 20.0% by mass, more preferably 3.0% to 15.0% by mass, and still more preferably 3.0% to 10.0% by mass with respect to the total mass of components in the treatment liquid excluding a solvent.

### <Surfactant>

The surfactant is not particularly limited as long as it is a compound having a hydrophilic group and a hydrophobic group (lipophilic group) in one molecule; and examples thereof include a nonionic surfactant, a cationic surfactant, and an anionic surfactant.

In many cases, the surfactant has at least one hydrophobic group selected from the group consisting of an aliphatic hydrocarbon group, an aromatic hydrocarbon group, and a group obtained by combining these groups.

The number of carbon atoms in the surfactant is preferably 16 to 100.

Examples of the nonionic surfactant include an ester-type nonionic surfactant, an ether-type nonionic surfactant, and an ester-ether-type nonionic surfactant; and an ether-type nonionic surfactant is preferable.

As the nonionic surfactant, for example, compounds exemplified in paragraph [0126] of WO2022/044893A can also be used, the contents of which are incorporated herein by reference.

Examples of the cationic surfactant include primary to tertiary alkylamine salts (for example, monostearylammonium chloride, distearylammonium chloride, and tristearylammonium chloride), and modified aliphatic polyamines (for example, polyethylenepolyamine).

Examples of the anionic surfactant include a sulfonic acid-based surfactant having a sulfonic acid group, a sulfated ester-based surfactant having a sulfated ester group, and a carboxylic acid-based surfactant having a carboxylic acid group.

As the anionic surfactant, for example, compounds exemplified in paragraphs [0116] to [0123] of WO2022/044893A can also be used, the contents of which are incorporated herein by reference.

### <pH Adjusting Agent>

The treatment liquid may contain a pH adjusting agent to adjust and maintain the pH of the treatment liquid.

The pH adjusting agent is a basic compound and an acidic compound different from the above-described compounds which can be contained in the treatment liquid (for example, the specific compound, the phosphonic acid compound, the basic amino acid, and the cyclodextrin). However, it is permissible to adjust the pH of the treatment liquid by adjusting the addition amount of each of the above-described components.

The basic compound is a compound which exhibits basicity (pH of more than 7.0) in an aqueous solution, and examples thereof include a basic inorganic compound and a basic organic compound.

Examples of the basic inorganic compound include alkali metal hydroxides such as sodium hydroxide and potassium hydroxide, and alkaline earth metal hydroxides.

Examples of the basic organic compound include a quaternary ammonium compound and an amine compound different from the compound represented by Formula (1).

Examples of the quaternary ammonium compound include tetraalkylammonium compounds such as tetramethylammonium hydroxide (TMAH), trimethylethylammonium hydroxide (TMEAH), dimethyldiethylammonium hydroxide (DMDEAH), methyltriethylammonium hydroxide (MTEAH), tetraethylammonium hydroxide (TEAH), tetrapropylammonium hydroxide (TPAH), and tetrabutylammonium hydroxide (TBAH); tris(hydroxymethyl)aminomethane, 2-hydroxyethyltrimethylammonium hydroxide, and benzyltrimethylammonium hydroxide (BTMAH).

Examples of the amine compound different from the compound represented by Formula (1) include an amine compound having only one nitrogen atom; and specific examples thereof include 2-dimethylamino-2-methyl-1-propanol (DMAMP), tris(hydroxymethyl)aminomethane (Tris), 2-amino-2-methyl-1-propanol (AMP), monoethanolamine (MEA), diethanolamine (DEA), and triethanolamine (TEA).

The acidic compound is a compound which exhibits acidity (a pH of less than 7.0) in an aqueous solution.

Examples of the acidic compound include an acidic inorganic compound.

Examples of the acidic inorganic compound include hydrochloric acid, sulfuric acid, nitric acid, nitrous acid, sulfurous acid, phosphoric acid, and boric acid.

As the acidic compound as the pH adjusting agent, a salt of the acidic compound may be used as long as it is an acid or an acid ion (anion) in an aqueous solution.

The pH adjusting agent may be used alone, or two or more types thereof may be used in combination.

A content of the pH adjusting agent can be selected depending on the type and amount of other components and the target pH of the treatment liquid. For example, the content of the pH adjusting agent is preferably 0.001% to 10% by mass, more preferably 0.01% to 5% by mass, and still more preferably 0.01% to 1% by mass with respect to the total mass of the treatment liquid.

### <Anticorrosion Agent>

The anticorrosion agent is not particularly limited as long as it is a compound having a function of preventing corrosion of an exposed surface of the object to be treated (particularly, tungsten and molybdenum); and examples thereof include a heterocyclic compound.

As the heterocyclic compound, a nitrogen-containing heterocyclic compound in which at least one of heteroatoms constituting a heterocycle is a nitrogen atom is preferable.

Examples of the nitrogen-containing heterocyclic compound include an azole compound, a purine compound, a pyrrole compound, a pyridine compound, a pyrazine compound, a pyrimidine compound, an indole compound, an indolizine compound, an indazole compound, a quinoline compound, and an oxazole compound; and a purine compound or an azole compound is preferable.

Specifically, as the anticorrosion agent, for example, compounds described in paragraphs [0046] to [0050] of WO2021/166571A can be used, the contents of which are incorporated herein by reference.

### <Organic Solvent>

Examples of the organic solvent include known organic solvents, for example, an alcohol-based solvent, a glycol-based solvent, a glycol ether-based solvent, and a ketone-based solvent.

It is preferable that the organic solvent is mixed with water at an optional ratio.

As the organic solvent, for example, compounds exemplified in paragraphs [0135] to [0140] of WO2022/044893A can be used, the contents of which are incorporated herein by reference.

The polyhydroxy compound having a molecular weight of 500 or more is a compound different from the above-described compounds which can be contained in the treatment liquid.

The above-described polyhydroxy compound is an organic compound having 2 or more (for example, 2 to 200) alcoholic hydroxyl groups in one molecule.

A molecular weight (in a case of having a molecular weight distribution, a weight-average molecular weight) of the above-described polyhydroxy compound is 500 or more, preferably 500 to 100,000 and more preferably 500 to 3,000.

As the polyhydroxy compound, compounds exemplified in paragraphs [0101] and [0102] of WO2022/014287A can be used, the contents of which are incorporated herein by reference.

Examples of the oxidant include a peroxide (hydrogen peroxide and the like), a persulfide (for example, a monopersulfide or a dipersulfide), a percarbonate, an acid thereof, and a salt thereof.

Examples of the oxidant also include an oxidative halide (a periodic acid such as iodic acid, metaperiodic acid, and orthoperiodic acid, and salts thereof), a perboric acid, a perboric acid salt, a cerium compound, and a ferricyanide (potassium ferricyanide or the like).

Examples of the reducing agent include catechol or a derivative thereof (for example, methylcatechol, gallic acid, pyrogallol, ellagic acid, catechol-4-acetic acid, catechin, and isoflavone), ascorbic acid or a derivative thereof (for example, isoascorbic acid, ascorbic acid sulfate ester, and ascorbic acid phosphate ester), and a mercapto compound (for example, mercaptosuccinic acid, 1-thioglycerol, 2-mercaptoethanol, 3-mercapto-1-propanol, and thioglycolic acid).

As the reducing agent, compounds described in paragraphs [0054] to [0065] of WO2019/187868A can also be used, the contents of which are incorporated herein by reference.

The fluoride is a compound which is a release source of an ion containing fluorine, and examples thereof include a compound containing an ion containing fluorine and a cation. Examples of the above-described ion containing fluorine include a fluoride ion (F⁻), a bifluoride ion (HF₂⁻), and a fluoride-containing ion (for example, MF₆ⁿ⁻; M: any atom and n: 1 to 3). Examples of the M include B, Al, Si, P, Ti, Zr, Nb, Sb, and Ta.

Specific examples of the fluoride include HF, NH₄F, H₂SiF₆, H₂TiF₆, H₂ZrF₆, HPF₆, and HBF₄.

### [Physical Properties of Treatment Liquid]

<pH>

The treatment liquid may be alkaline or acidic.

From the viewpoint that the effect of the present invention is more excellent, a pH of the treatment liquid is preferably 1.0 to 12.0, more preferably 3.0 to 9.0, still more preferably 5.0 to 8.0, and particularly preferably 7.0 to 8.0. By satisfying the above-described suitable range of the pH, the solubility of the residue is improved, and the dissolution of tungsten and molybdenum can be further suppressed.

In addition, from the viewpoint that the corrosion inhibition properties of tungsten is more excellent, the pH of the treatment liquid is preferably 9.0 or less, and more preferably 8.0 or less; and from the viewpoint that the organic residue removability is more excellent, the pH of the treatment liquid is preferably 3.0 or more, more preferably 5.0 or more, and still more preferably 7.0 or more.

The pH of the treatment liquid can be measured by a method based on JIS Z 8802-1984 using a known pH meter. A measurement temperature of the pH is 25° C.

### <Metal Content>

A content (measured as ion concentration) of all metals (for example, metal elements of Fe, Co, Na, Cu, Mg, Mn, Li, Al, Cr, Ni, Zn, Sn, and Ag) contained as impurities in the treatment liquid is preferably 5 mass ppm or less, and more preferably 1 mass ppm or less. It is assumed that, in manufacturing of a cutting-edge semiconductor element, the treatment liquid having even higher purity is required, and thus the metal content is more preferably a value lower than 1 mass ppm, that is, lower than a value of mass ppb order, particularly preferably 100 mass ppb or less, and most preferably less than 10 mass ppb. The lower limit thereof is preferably 0.

Examples of a method for reducing the metal content include performing a purifying treatment such as distillation and filtration using an ion exchange resin or a filter at a stage of raw materials used in the production of the treatment liquid or a stage after the production of the treatment liquid.

Other examples of the method for reducing the metal content include using a container with less elution of impurities, which will be described later, as a container that accommodates the raw material or the produced treatment liquid. In addition, other examples thereof include lining an interior wall of the pipe with a fluororesin to prevent the elution of metal components from a pipe or the like during the production of the treatment liquid.

### <Coarse Particles>

The treatment liquid may contain coarse particles, but it is preferable that a content thereof is low.

The coarse particles mean particles having a diameter (particle size) of 1 μm or more, in a case where a shape of the particles is regarded as a sphere.

The coarse particles contained in the treatment liquid correspond to, for example, particles such as rubbish, dust, organic solid, and inorganic solid, which are contained as impurities in raw materials, and particles such as rubbish, dust, organic solid, and inorganic solid, which are brought in as contaminants during the preparation of the treatment liquid, in which those particles are finally present as particles without being dissolved in the treatment liquid.

The content of the coarse particles in the treatment liquid, in terms of content of particles having a particle size of 1 μm or more, is preferably 100 or less and more preferably 50 or less per 1 mL of the treatment liquid. The lower limit thereof is preferably 0 or more, and more preferably 0.01 or more per milliliter of the treatment liquid.

The content of the coarse particles present in the treatment liquid can be measured in a liquid phase by using a commercially available measuring device in a light scattering type liquid particle measuring method using a laser as a light source.

Examples of a method for removing the coarse particles include a purification treatment such as filtering, which will be described later.

It is also preferable that the treatment liquid does not contain abrasive particles.

### [Production Method of Treatment Liquid]

The treatment liquid according to the embodiment of the present invention can be produced by a known method. Hereinafter, a production method of the treatment liquid will be described in detail.

### [Liquid Preparation Step]

The treatment liquid can be produced, for example, by mixing the above-described components.

Examples of the method for preparing the treatment liquid include a method in which the specific compound, the phosphonic acid compound, and the optional component as necessary are sequentially charged into a container containing purified pure water, the mixture is stirred and mixed, and a pH adjusting agent is added as necessary to adjust the pH of the mixed solution, thereby preparing the treatment liquid. In addition, in a case where the respective components are charged into the container, the respective components may be charged at once, or may be charged in a divided manner a plurality of times.

As a stirring device and a stirring method used for preparing the treatment liquid, a known device may be used as a stirrer or a disperser. Examples of a stirrer include an industrial mixer, a portable stirrer, a mechanical stirrer, and a magnetic stirrer. Examples of the disperser include an industrial disperser, a homogenizer, an ultrasonic disperser, and a beads mill.

The mixing of the respective components in the step of preparing the treatment liquid, a refining treatment described later, and storage of the produced treatment liquid are preferably performed at 40° C. or lower, and more preferably performed at 30° C. or lower. The lower limit thereof is preferably 5° C. or higher and more preferably 10° C. or higher. By preparing, treating, and/or storing the treatment liquid in the above-described temperature range, stable performance can be maintained for a long period of time.

### <Purification>

It is preferable to subject any one or more of the raw materials for preparing the treatment liquid to a purification treatment in advance. Examples of the purification treatment include known methods such as distillation, ion exchange, and filtration (filtering).

Regarding a degree of purification, it is preferable to carry out the purification treatment until the purity of the raw material is 99% by mass or more, and it is more preferable to carry out the purification treatment until the purity of the stock solution is 99.9% by mass or more. The upper limit thereof is preferably 99.9999% by mass or less.

Examples of a method of the purification treatment include a method of passing the raw material through an ion exchange resin, a reverse osmosis membrane (RO membrane), or the like, reprecipitation, distillation of a raw material, and filtering.

The purification treatment may be performed by combining a plurality of the above-described purification methods. For example, the raw materials are subjected to primary purification by passing through an RO membrane, and then subjected to secondary purification by passing through a purification device consisting of a cation-exchange resin, an anion-exchange resin, or a mixed-bed type ion exchange resin.

In addition, the purification treatment may be performed a plurality of times.

The filter which is used for filtering is not particularly limited as long as it has been used in application for filtering and the like in the related art. Examples thereof include filters formed of fluororesins such as polytetrafluoroethylene (PTFE) and tetrafluoroethylene perfluoroalkyl vinyl ether copolymer (PFA), polyamide-based resins such as nylon, polyarylsulfone (PAS), polyolefin resins (including those with a high density and an ultra-high molecular weight) such as polyethylene and polypropylene (PP), or the like. Among these materials, a material selected from the group consisting of polyethylene, polypropylene (including a high-density polypropylene), a fluororesin (including PTFE and PFA), and a polyamide-based resin (including nylon) is preferable; and a filter of the fluororesin is more preferable. By carrying out filtering of the raw materials using a filter formed of these materials, high-polarity foreign matters which are likely to cause defects can be more effectively removed.

### <Container>

The treatment liquid (including an aspect of a diluted treatment liquid described later) can be added in any container to be stored and transported as long as problems such as corrosiveness do not arise.

In application for a semiconductor, the container is preferably a container which has a high degree of cleanliness inside the container and in which the elution of impurities from an interior wall of an accommodating portion of the container into the each liquid is suppressed. Examples of such a container include various containers commercially available as a container for a semiconductor treatment liquid, such as “CLEAN BOTTLE” series manufactured by AICELLO MILIM CHEMICAL Co., Ltd. and “PURE BOTTLE” manufactured by Kodama Plastics Co., Ltd., but the container is not limited thereto.

In addition, as the container, containers exemplified in paragraphs [0121] to [0124] of WO2022/004217A can also be used, the contents of which are incorporated herein by reference.

The inside of these containers is preferably cleaned before filling the treatment liquid. With regard to a liquid used for the cleaning, the amount of metal impurities in the liquid is preferably reduced. The treatment liquid may be bottled in a container such as a gallon bottle and a coated bottle after the production, and then may be transported and stored.

In order to prevent changes in the components of the treatment liquid during the storage, the inside of the container may be purged with an inert gas (such as nitrogen and argon) having a purity of 99.99995% by volume or more. In particular, a gas with a low moisture content is preferable. In addition, during the transportation and the storage, the temperature may be normal temperature or may be controlled in a range of −20° C. to 20° C. to prevent deterioration.

### <Clean Room>

It is preferable that handlings including production of the treatment liquid, opening and cleaning of the container, and filling of the treatment liquid, treatment analysis, and measurements are all performed in a clean room. It is preferable that the clean room meets the 14644-1 clean room standard. It is preferable that the clean room satisfies any one of International Organization for Standardization (ISO) Class 1, ISO Class 2, ISO Class 3, or ISO Class 4, it is more preferable that the clean room satisfies ISO Class 1 or ISO Class 2, and it is still more preferable that the clean room satisfies ISO Class 1.

### [Dilution Step]

The above-described treatment liquid may be used for treating an object to be treated, as a diluted treatment liquid after undergoing a dilution step of diluting the treatment liquid using a diluent such as water.

The diluted treatment liquid is also an aspect of the treatment liquid according to the embodiment of the present invention as long as it satisfies the requirements of the present invention.

It is preferable to subject the diluent which is used in the dilution step to a purification treatment in advance. In addition, it is more preferable that the diluted treatment liquid obtained in the dilution step is subjected to a purification treatment.

Examples of the purification treatment include the ion component reducing treatment using the ion exchange resin, the RO membrane, or the like, and the foreign matter removal using filtering, which are described as the purification treatment for the treatment liquid above, and it is preferable to carry out any one of these treatments.

A dilution rate of the treatment liquid in the dilution step may be appropriately adjusted depending on the type and content of each component and the object to be treated, but the ratio (dilution rate) of the diluted treatment liquid to the treatment liquid before the dilution is preferably 10 to 10,000 times, more preferably 20 to 3,000 times, still more preferably 50 to 1,000 times, and particularly preferably 75 to 150 times in terms of mass ratio or volume ratio (volume ratio at 23° C.).

In addition, from the viewpoint of more excellent residue removability, the treatment liquid is preferably diluted with water (preferably, ultrapure water).

A change in pH before and after the dilution (a difference between the pH of the treatment liquid before the dilution and the pH of the diluted treatment liquid) is preferably 2.5 or less, more preferably 2.0 or less, and still more preferably 1.8 or less.

It is preferable that the pH of the treatment liquid before the dilution and the pH of the diluted treatment liquid are each in the above-described suitable aspect. The pH of the diluted treatment liquid may be adjusted using the above-described pH adjusting agent.

A specific method for the dilution step of diluting the treatment liquid may be performed according to the step of preparing the treatment liquid described above. A stirring device and a stirring method used in the dilution step may also be performed using the known stirring device described in the step of preparing the treatment liquid above.

### [Applications]

The treatment liquid is used for treatment of an object to be treated in a manufacturing process of the semiconductor.

Examples of the object to be treated include an object to be treated (for example, a semiconductor substrate) containing a metal, and a pad used for treatment of the semiconductor substrate.

The object to be treated containing a metal is preferably an object to be treated, which has been subjected to a chemical mechanical polishing (CMP) treatment, and more preferably an object to be treated containing at least one of tungsten or molybdenum, which has been subjected to a CMP treatment. That is, it is preferable that the treatment liquid is used for the treatment of the object to be treated containing at least one of tungsten or molybdenum, which has been subjected to the CMP treatment.

Examples of the above-described pad include a polishing pad and a buffing pad, and a pad (polishing pad) used for the CMP treatment is more preferable. That is, it is also preferable that the treatment liquid is used for the treatment of the pad used for the CMP treatment.

As described above, in a case where the treatment liquid is used, the treatment liquid may be used as a diluted treatment liquid obtained by diluting the treatment liquid.

### [Object to be Treated Containing Metal]

As the object to be treated containing a metal, a semiconductor substrate containing a metal is preferable.

In a case where the semiconductor substrate contains a metal, for example, the metal may be present on any of front and back surfaces, side surfaces, inside of a groove, and the like of the semiconductor substrate. In addition, in a case where the semiconductor substrate contains a metal, the metal includes not only a case in which the metal is directly present on the surface of the semiconductor substrate, but also a case in which the metal is present on the semiconductor substrate through another layer.

Examples of the above-described metal include at least one metal M selected from the group consisting of tungsten (W), molybdenum (Mo), copper (Cu), cobalt (Co), ruthenium (Ru), aluminum (Al), titanium (Ti), tantalum (Ta), chromium (Cr), hafnium (Hf), osmium (Os), platinum (Pt), nickel (Ni), manganese (Mn), iron (Fe), zirconium (Zr), palladium (Pd), lanthanum (La), niobium (Nb), and iridium (Ir); and at least one metal selected from the group consisting of W, Mo, Cu, Co, and Ru is preferable, at least one metal selected from the group consisting of W and Mo is more preferable, and W is still more preferable. That is, as the object to be treated, an object to be treated containing at least one of W or Mo is preferable, and an object to be treated containing W is more preferable.

The metal is preferably present as a metal layer containing a metal. Examples of a form of the metal contained in the metal layer include a simple substance of the metal M and an alloy containing the metal M.

Among these, the object to be treated preferably has a metal layer containing the metal M, more preferably has a metal layer containing W, Mo, Cu, Co, or Ru, still more preferably has a metal layer containing W or Mo, and particularly preferably has a metal layer containing W.

Examples of the metal layer containing W include a metal film consisting of only metal tungsten (W metal film) and a metal film made of an alloy consisting of tungsten and another metal (W alloy metal film). Examples of the tungsten alloy metal film include a tungsten-titanium alloy metal film (W and Ti-containing metal film) and a tungsten-cobalt alloy metal film (W and Co-containing metal film). The W-containing film is used, for example, as a barrier metal or a connecting portion between a via and a wiring line.

Examples of the metal layer containing Mo include a metal film consisting of only molybdenum (Mo metal film) and a metal film made of an alloy consisting of molybdenum and another metal (Mo alloy metal film). Examples of the other metal in the Mo alloy metal film include Cu, Co, W, Ru, Al, Ti, and Ta. The Mo-containing film is used, for example, as a barrier metal or a connecting portion between a via and a wiring line.

The object to be treated with the treatment liquid may have, for example, a semiconductor substrate, an insulating film, a metal wire film, and a barrier metal, in addition to the above-described metal layer.

Examples of the wafer constituting the semiconductor substrate include a wafer consisting of a silicon-based material, such as a silicon (Si) wafer, a silicon carbide (SiC) wafer, and a silicon-including resin-based wafer (glass epoxy wafer), a gallium phosphide (GaP) wafer, a gallium arsenic (GaAs) wafer, and an indium phosphide (InP) wafer.

Examples of the silicon wafer include an n-type silicon wafer in which a silicon wafer is doped with a pentavalent atom (for example, phosphorus (P), arsenic (As), antimony (Sb), or the like) and a p-type silicon wafer in which a silicon wafer is doped with a trivalent atom (for example, boron (B), gallium (Ga), or the like). Examples of the silicon of the silicon wafer include amorphous silicon, single crystal silicon, polycrystalline silicon, and polysilicon.

Among these, a wafer consisting of a silicon-based material, such as a silicon wafer, a silicon carbide wafer, and a resin-based wafer (a glass epoxy wafer) including silicon, is preferable.

Examples of the insulating film include a silicon oxide film (for example, a silicon dioxide (SiO₂) film, a tetraethyl orthosilicate (Si(OC₂H₅)₄) film (a TEOS film), a silicon nitride film (for example, silicon nitride (Si₃N₄), and silicon nitride carbide (SiNC)), and a low-dielectric constant (Low-k) film (for example, a carbon-doped silicon oxide (SiOC) film, a black diamond (BD) film, and a silicon carbide (SiC) film); and a low-dielectric-constant (Low-k) film is preferable.

Examples of the wiring metal include copper (Cu), a copper-aluminum alloy (CuAl), a copper-titanium alloy (CuTi), a copper-chromium alloy (CuCr), a copper-manganese alloy (CuMn), a copper-tantalum alloy (CuTa), a copper-niobium alloy (CuNb), a copper-tungsten alloy (CuW), silver (Ag), and gold (Au).

Examples of the barrier metal include tantalum (Ta), tantalum nitride (TaN), titanium nitride (TiN), cobalt (Co), a cobalt alloy, ruthenium (Ru), and a ruthenium alloy.

A method of forming the insulating film, the W-containing film, the Mo-containing film, and the like described above on the wafer constituting the semiconductor substrate is not particularly limited as long as it is a method generally performed in this field.

Examples of the method of forming the insulating film include a method in which the wafer constituting the semiconductor substrate is subjected to a heat treatment in the presence of oxygen gas to form a silicon oxide film, and then a gas of silane and ammonia is introduced thereto to form a silicon nitride film by a chemical vapor deposition (CVD) method.

Examples of the method of forming the W-containing film and the Mo-containing film include a method of forming a circuit on the wafer having the above-described insulating film by a known method such as a resist, and then forming the metal layer by a method such as plating, a physical vapor deposition (PVD) method, and a CVD method. The object to be treated may have a layer for forming the W-containing film or the Mo-containing film on the above-described insulating film.

### <CMP Treatment>

It is preferable that the treatment liquid is used for the object to be treated, which has been subjected to the CMP treatment. That is, the object to be treated is preferably an object to be treated containing a metal, which has been subjected to a CMP treatment, and more preferably a semiconductor substrate containing a metal, which has been subjected to a CMP treatment.

The CMP treatment is a treatment in which a surface of the substrate having a layer selected from the metal wire film, the barrier metal, and the insulating film is flattened by a combined action of a chemical action and a mechanical polishing using a polishing slurry containing abrasive particles (abrasive grains). Specifically, for example, the surface of the object to be treated and the polishing pad are brought into contact with each other, and the object to be treated and the polishing pad are slid relative to each other while supplying the polishing slurry to a contact portion. As a result, the member on the surface of the object to be treated is removed and flattened by a frictional force with the polishing pad, the polishing slurry, and the surface of the object to be treated and by a chemical action of the polishing slurry. The above-described polishing pad is not particularly limited, and a pad generally used in the CMP treatment, such as nonwoven fabric, foamed polyurethane, and porous fluororesin, can be used.

A surface of the object to be treated which has been subjected to the CMP treatment may have residues such as abrasive grains (for example, silica and alumina) used in the CMP treatment, a polished metal wire film, and/or metal impurities (metal residue) derived from the barrier metal. In addition, an organic substance derived from a CMP treatment liquid used in the CMP treatment may remain as the residues. For example, since these residues may cause a short-circuit between wiring lines and deteriorate electrical characteristics of the semiconductor substrate, the semiconductor substrate which has been subjected to the CMP treatment is subjected to a cleaning treatment for removing these residues from the surface.

The treatment liquid according to the embodiment of the present invention is preferably used as a cleaning liquid for the cleaning treatment after the CMP treatment as described above. Among these, in a case where the metal in the above-described object to be treated contains at least one of tungsten or molybdenum, an iron-containing substance is usually used in the CMP treatment, and the residues can be efficiently removed by the treatment liquid according to the embodiment of the present invention.

Specific examples of the object to be treated, which has been subjected to the CMP treatment, include substrates which have been subjected to the CMP treatment, described in Journal of the Japan Society for Precision Engineering, Vol. 84, No. 3, 2018, but the present invention is not limited thereto.

### <Pad Cleaning Treatment (Buff Cleaning Treatment)>

The surface of the object to be treated may be subjected to a pad cleaning treatment (buff cleaning treatment) after the CMP treatment.

The pad cleaning treatment (buff cleaning treatment) is a treatment of reducing residues present on the surface of the object to be treated using a pad. Specifically, the surface of the object to be treated, which has been subjected to the CMP treatment, is brought into contact with the pad, and the object to be treated and the pad are relatively slid while supplying a composition for pad cleaning to a contact portion. As a result, the residues on the surface of the object to be treated are removed by a frictional force of the pad and the chemical action of the composition for pad cleaning. That is, the above-described pad cleaning treatment is different from a treatment of treating the pad as the object to be treated using the treatment liquid according to the embodiment of the present invention, which will be described later. In addition, the composition for pad cleaning is intended to be a composition (composition for pad cleaning treatment) used for the above-described pad cleaning treatment (buff cleaning treatment).

The above-described pad is not particularly limited, and can be appropriately selected depending on the type of the object to be treated, the type of residues to be removed, and the device to be used. As the pad, a polishing pad used in the CMP treatment may be used, or a buff pad such as a foamed polyurethane-based buff pad, a nonwoven fabric, a suede-based buff pad, and a sponge may be used. The pad cleaning treatment using the pad includes a treatment called rinse polishing, buff cleaning, or buff polishing.

As the above-described composition for pad cleaning, a known cleaning composition can be used depending on the type of the object to be treated and the type and amount of the residues to be removed. Examples of a component contained in the composition for pad cleaning include a water-soluble polymer such as polyvinyl alcohol, a dispersion medium such as water, an acid such as nitric acid, a basic compound such as an amine, a surfactant, an antibacterial agent, and a phosphonic acid compound. The composition for pad cleaning does not contain abrasive particles.

From the viewpoint of excellent removability of the residue, the above-described composition for pad cleaning also preferably contains a surfactant. Examples of the surfactant include the surfactant which may be contained in the treatment liquid described above; and a nonionic surfactant is preferable, an ester-type nonionic surfactant is more preferable, and polyoxyethylene sorbitan fatty acid ester or sorbitan fatty acid ester is still more preferable. A content of the surfactant in the composition for pad cleaning is preferably 0.01% to 20% by mass.

In addition, the above-described composition for pad cleaning may be acidic, basic, or neutral, and is preferably acidic (more preferably a pH of 6 or less) or basic (more preferably a pH of 8 or more).

The device and conditions used in the pad cleaning treatment can be appropriately selected from known devices and conditions depending on the type of the treatment object and the type and amount of the residues to be removed. For example, a treatment method described in paragraphs [0085] to [0088] of WO2017/169539A can be used, the contents of which are incorporated herein by reference.

In addition, as one embodiment of the pad cleaning treatment, it is also preferable to perform a pad cleaning treatment on the object to be treated, using the treatment liquid according to the embodiment of the present invention as the composition for pad cleaning.

The treatment liquid to be subjected to the pad cleaning treatment may be a diluted treatment liquid.

The pad cleaning treatment may be performed only once or may be performed twice or more. For example, after the CMP treatment, the object to be treated may be subjected to a pad cleaning treatment using a polishing pad and a pad cleaning treatment using a buff pad.

### [Pad]

The pad as the object to be treated using the treatment liquid is not particularly limited as long as it is used in the treatment process of the semiconductor substrate, but is preferably a pad (polishing pad) used for the CMP treatment.

After the CMP treatment, the polishing pad used for the CMP treatment may be adhered with residues such as abrasive grains used in the CMP treatment, a polished metal wire film, metal impurities derived from the barrier metal, and organic substance derived from the CMP treatment liquid. In a case where the CMP treatment of the next object to be treated is performed in a state in which these residues are adhered to the polishing pad, defects such as polishing scratches due to the residues and adhesion of the residues may occur on the surface of the object to be treated. Therefore, it is preferable that the polishing pad is subjected to the cleaning treatment after the CMP treatment or before the CMP treatment.

It is also preferable that the treatment liquid is used as a cleaning liquid for the cleaning treatment of the polishing pad used in the CMP treatment as described above. The treatment liquid to be subjected to the pad cleaning treatment may be a diluted treatment liquid.

The pad as the object to be treated using the treatment liquid may be a buff pad subjected to the above-described pad cleaning treatment. In other words, the treatment liquid may be used as a treatment liquid for the pad used for the buff cleaning.

### [Treatment Method of Object to be Treated]

The treatment liquid can be used by a known method.

Examples of the method of using the treatment liquid include a treatment method for an object to be treated, which includes a step of bringing the object to be treated into contact with the treatment liquid. Hereinafter, the step of bringing the object to be treated into contact with the treatment liquid is also referred to as “contact step”. The above-described object to be treated is as described above, and may be, for example, an object to be treated containing a metal, or a pad.

The method of bringing the object to be treated into contact with the treatment liquid is not particularly limited; and examples thereof include a method of immersing the object to be treated in the treatment liquid contained in a tank, a method of spraying the treatment liquid onto the object to be treated, a method of flowing the treatment liquid onto the object to be treated, and a combination thereof. The above-described method may be appropriately selected depending on the purpose.

The contact between the object to be treated and the treatment liquid in the contact step may be carried out only once or twice or more. In a case of carrying out the contact twice or more, the same method may be repeated or different methods may be combined.

A temperature of the treatment liquid is not particularly limited, but from the viewpoint of more excellent cleanability and further suppressing damage to the member, it is preferably 10° C. to 60° C. and more preferably 15° C. to 50° C.

It is preferable that a pH of the treatment liquid and a pH of the diluted treatment liquid are each in the above-described suitable aspect of pH.

In a case of treating the object to be treated containing a metal, a manner usually performed in the field may be appropriately adopted. For example, scrub cleaning in which a cleaning member such as a brush is physically brought into contact with a surface of the object to be treated while supplying the treatment liquid to remove residues and the like, spinning (dropping) cleaning in which the treatment liquid is dropped while rotating the object to be treated, or the like may be used. From the viewpoint that impurities remaining on a surface of the object to be treated can be further reduced, it is preferable that the object to be treated immersed in the treatment liquid is subjected to an ultrasonic treatment.

The treatment method for the object to be treated containing a metal may be a single-wafer method or a batch method. The single-wafer method is a method of treating one object to be treated at a time; and the batch method is a method of treating a plurality of objects to be treated at the same time.

In a case of treating the pad, a manner usually performed in the field may be appropriately adopted. For example, a method of bringing the pad into contact with the object to be treated which is not polished by the pad while supplying the treatment liquid and sliding the pad and the object to be treated may be used.

A contact time between the object to be treated and the treatment liquid may be appropriately changed depending on the type and content of each component contained in the treatment liquid, the use target and purpose of the treatment liquid, but it is preferably 10 to 120 seconds, more preferably 20 to 90 seconds, and still more preferably 30 to 60 seconds.

A supply amount (supply rate) of the treatment liquid is preferably 50 to 5,000 mL/min, and more preferably 500 to 2,000 mL/min.

In the contact step, a mechanical stirring method may be used in order to further improve the cleaning ability of the treatment liquid.

Examples of the mechanical stirring method include a method of circulating the treatment liquid on the object to be treated, a method of flowing or spraying the treatment liquid on the object to be treated, and a method of stirring the treatment liquid with ultrasonic wave or megasonic wave.

It is preferable that the above-described treatment step is a cleaning step of removing residues on the surface of the object to be treated by bringing the object to be treated into contact with the treatment liquid. A preferred aspect of the cleaning step is the same as the preferred aspect of the contact step described above.

In addition, after the contact step, a step of bringing the object to be treated into contact with a rinsing liquid (hereinafter, also referred to as “rinsing step”) may be performed. By performing the rinsing step, the object to be treated, obtained in the contact step, is washed with a rinsing liquid, and the residues can be efficiently removed.

The rinsing step is preferably a step which is carried out continuously subsequently after the cleaning step of the semiconductor substrate, in which the object to be treated is rinsed with a rinsing liquid. The rinsing step may be performed using the above-described mechanical stirring method.

Examples of the rinsing liquid include water (preferably, DI water), methanol, ethanol, isopropyl alcohol (IPA), N-methylpyrrolidinone, γ-butyrolactone, dimethyl sulfoxide, ethyl lactate, and propylene glycol monomethyl ether acetate. In addition, an aqueous rinsing liquid having a pH of more than 8.0 (aqueous ammonium hydroxide which has been diluted, or the like) may be used.

As the method in which the rinsing liquid is brought into contact with the object to be treated, the method in which the treatment liquid is brought into contact with the object to be treated can be similarly applied.

A contact time between the object to be treated and the rinsing liquid can be appropriately changed depending on the type and content of each component contained in the treatment liquid, and the use target and purpose of the treatment liquid. The contact time is practically 10 to 120 seconds, preferably 20 to 90 seconds and more preferably 30 to 60 seconds.

After the contact step and/or the rinsing step described above, a drying step of drying the object to be treated may be performed.

Examples of the drying method include a spin drying method, a method of flowing a dry gas onto the object to be treated, a method of heating a substrate by a heating unit such as a hot plate and an infrared lamp, a Marangoni drying method, a Rotagoni drying method, an IPA drying method, and a method of combining any of these methods.

### [Manufacturing Method of Electronic Device]

The above-described treatment method for an object to be treated can be suitably applied to a manufacturing process of an electronic device.

The above-described treatment method may be performed in combination before or after other steps performed on a substrate. The above-described treatment method may be incorporated into other steps while performing the treatment method, or the above-described treatment method may be incorporated into the other steps.

Examples of the other steps include a step of forming each structure such as a metal wire, a gate structure, a source structure, a drain structure, an insulating film, a ferromagnetic layer, and a non-magnetic layer (for example, layer formation, etching, chemical mechanical polishing, modification, or the like), a resist forming step, an exposure step and a removal step, a heat treatment step, a cleaning step, and an examination step.

The above-described treatment method may be performed at any stage among the back-end process (BEOL: back end of the line), the middle process (MOL: middle of the line), and the front-end process (FEOL: front end of the line); and it is preferable that the treatment method be performed in a front-end process or a middle process.

### EXAMPLES

Hereinbelow, the present invention will be described in more detail with reference to Examples.

The materials, the amounts and proportions of the materials used, the details of treatments, the procedure of treatments, and the like shown in the following Examples can be appropriately modified as long as the gist of the present invention is maintained. Therefore, the scope of the present invention should not be construed as being limited to Examples shown below.

In the following Examples, a pH of the treatment liquid was measured at 25° C. using a pH meter (manufactured by HORIBA, Ltd., model “F-74”) in accordance with JIS Z 8802-1984.

In addition, in production of treatment liquids of Examples and Comparative Examples, all of handling of a container, and production, filling, storage, and analytical measurement of the treatment liquids were performed in a clean room satisfying a level of ISO Class 2 or lower.

### [Raw Materials of Treatment Liquid]

The following compounds were used to produce a treatment liquid. As various components used in Examples and Comparative Examples, those all classified into a semiconductor grade or a high-purity grade equivalent thereto were used.

### [Specific Compound and Comparative Compound]

N-ethylethylenediamine (EEDA)
1,2-Propanediamine (12PDA)
1,3-Propanediamine (13PDA)
1,3-Diaminopentane (13DAP)
N-(3-Aminopropyl)diethanolamine (3APDEA)
Bis(2-aminoethyl)amine (B2AEA)
Bis(3-aminopropyl)amine (BAPA)
N,N,N′,N′-Tetrakis(2-hydroxyethyl)ethylenediamine (TK2HEEDA)
3-(Dibutylamino)propylamine (3DBAPA)
N,N′-Bis(3-aminopropyl)ethylenediamine (BAPEDA)
Tris(3-aminopropyl)amine (T3APA)
N,N,N′,N″,N″-pentamethyldiethylenetriamine (PMDETA)
Tris(2-aminoethyl)amine (T2AEA)
N,N,N′,N″,N′″,N′″-Hexamethyltriethylenetetramine (HMTEEA)
Ethylenediamine (EDA)
Polyethyleneimine (Mw=600)

### [Phosphonic Acid Compound]

1-hydroxyethylidene-1,1′-diphosphonic acid (HEDPO)
Ethylenediaminetetramethylenephosphonic acid (EDTMP)
Diethylenetriaminepentakis(methylphosphonic acid) (DTPMP)
Nitrilotris(methylenephosphonic acid) (NMPA)
Phytic acid
2-Phosphonobutane-1,2,4-tricarboxylic acid (PBTCA)
Iminodi(methylenephosphonic acid) (IDMP)
Ethylaminebis(methylenephosphonic acid) (EABMP)
Methylaminebis(methylenephosphonic acid) (MADP)
N,N-Dimethylaminomethylphosphonic acid (DAMP)
Hydroxymethylphosphonic acid (HMP)
Aminomethylphosphonic acid (AMPA)
Methylphosphonic acid (MP)

### [Basic Amino Acid]

Arginine
Histidine
Lysine

### [Antibacterial Agent]

Benzethonium chloride
Sorbic acid
Dehydroacetic acid
Cresol
Methyl isothiazolinone (MIT)
Octyl isothiazolinone (OIT)
Benzisothiazolinone (BIT)
Benzoic acid
Salicylic acid

### [Organic Acid]

Tartaric acid
Citric acid
Malonic acid
Succinic acid
Malic acid

### [Other Additives]

β-Cyclodextrin (β-CD)
Polyacrylic acid (Mw=5,000)
Acrylic acid-sulfonic acid copolymer (product name: ARON A-6012 (manufactured by TOAGOSEI CO., LTD.))
Polysulfonic acid (Mw=12,000)

### [Production of Treatment Liquid]

A production method of the treatment liquid will be described.

The above-described compounds were added with the blending amounts shown in the following tables, and sufficiently stirred to obtain a concentrated solution. The obtained concentrated solution was diluted with deionized water as a diluent at a dilution ratio (volume ratio) described in the column of the dilution ratio in the following tables, thereby obtaining a treatment liquid of each of Examples and Comparative Examples. The pH in the tables is a pH of the treatment liquid obtained by dilution, and the pH was adjusted by adding a component selected from the group consisting of tris(hydroxymethyl)aminomethane, DMAMP, Tris, DEA, TEA, MEA, and sulfuric acid as a pH adjusting agent as necessary.

In the treatment liquid, the remaining component (remainder) other than components specified as the components of the treatment liquid in the tables was deionized water and the pH adjusting agent. In any of the treatment liquids, a content of the pH adjusting agent was less than 1% by mass with respect to the total mass of the treatment liquid.

### [Evaluation 1]

### [Organic Residue Removability]

Organic residue removability in a case of treating the object to be treated subjected to the CMP treatment in the following procedure using the treatment liquid produced by the above-described method was evaluated.

Using FREX300S-II (polishing device, manufactured by EBARA CORPORATION), a wafer (diameter: 12 inches) having a W film on the surface was polished under conditions of a polishing pressure of 2.0 psi (138 hPa), a polishing liquid supply rate of 0.28 mL/(min·cm²), and a polishing time of 60 seconds, using FSL3400C (product name, manufactured by Fujifilm Electronics Materials Co., Ltd.) to which 3% by mass of hydrogen peroxide was added as a polishing liquid.

Thereafter, the obtained wafer subjected to the CMP treatment was subjected to scrub cleaning for 60 seconds using the treatment liquid of each of Examples and Comparative Examples, adjusted to room temperature (23° C.), washed with deionized water for 30 seconds, and then subjected to a drying treatment.

A defect detection device (ComPlus-II, manufactured by AMAT) was used to measure the number of detections of signal intensities corresponding to defects having a length of more than 0.1 μm on the obtained polished surface of the wafer. The above-described defects were observed with defect review SEM (SEMVISION G5, manufactured by AMAT), and the number of defects of organic substance on the polished surface of the wafer was obtained by counting the defects recognized as organic substance.

The organic residue removability was evaluated according to the following evaluation standard from the obtained number of defects. An evaluation of D or higher is preferable in terms of practical use.
A: number of defects per wafer was less than 20.
B: number of defects per wafer was 20 or more and less than 30.
C: number of defects per wafer was 30 or more and less than 50.
D: number of defects per wafer was 50 or more and less than 100.
E: number of defects per wafer was 100 or more.

### [Corrosion Inhibition Properties]

Corrosion inhibition properties for tungsten were evaluated using the treatment liquid produced by the above-described method in the following procedure.

A 2×2 cm W wafer was prepared. The above-described wafer was placed in a container filled with the treatment liquid of each of Examples or each of Comparative Examples, and subjected to an immersion treatment at room temperature (25° C.) for 30 minutes. Thereafter, a film thickness of the wafer obtained using VR250 (resistivity meter, manufactured by Kokusai Electric Semiconductor Service Inc.) was measured, and an etching rate (Å/min) was determined from the difference in film thickness before and after the above-described immersion treatment.

The corrosion inhibition properties were evaluated according to the following evaluation standard from the etching rate. As the etching rate was lower, the corrosion inhibition properties were more excellent. An evaluation of D or higher is preferable in terms of practical use.
A: less than 0.4 Å/min
B: 0.4 Å/min or more and less than 0.6 Å/min
C: 0.6 Å/min or more and less than 0.8 Å/min
D: 0.8 Å/min or more and less than 1.0 Å/min
E: 1.0 Å/min or more

### [Iron Oxide Residue Removability]

Iron oxide residue removability was evaluated using the treatment liquid produced by the above-described method in the following procedure.

A 2×2 cm wafer having a Fe₂O₃ (iron oxide) film formed on a surface was prepared. The above-described wafer was placed in a container filled with the treatment liquid of each of Examples or each of Comparative Examples, and subjected to an immersion treatment at room temperature (25° C.) for 30 minutes. Thereafter, the film thickness of the wafer obtained using ellipsometry (M-2000XI, manufactured by J. A. Woollam Japan Co., Ltd.) was measured, and an etching rate (Å/min) was obtained from the difference in film thickness before and after the above-described immersion treatment.

The iron oxide residue removability was evaluated according to the following evaluation standard from the etching rate. As the etching rate was higher, dissolving ability of iron oxide was more excellent, that is, the iron oxide residue removability was more excellent. An evaluation of D or higher is preferable in terms of practical use.
A: 10.0 Å/min or more
B: 8.0 Å/min or more and less than 10.0 Å/min
C: 6.0 Å/min or more and less than 8.0 Å/min
D: 3.0 Å/min or more and less than 6.0 Å/min
E: less than 3.0 Å/min

### [Result]

The formulations of the treatment liquids of Examples and the evaluation results are shown in Tables 1 to 4. Table 4 is a continuation of Table 3. For example, the treatment liquid of Example 51 was a liquid obtained by diluting 100 times a concentrated solution containing 0.5% by mass of EEDA, 3.0% by mass of HEDPO, 0.5% by mass of arginine, 0.05% by mass of sorbic acid, 0.4% by mass of tartaric acid, and 0.5% by mass of polyacrylic acid.

In the tables, the column of “Amount” indicates the content (% by mass) of each component with respect to the total mass of the concentrated solution.

In the tables, the column of “a/b” indicates the mass ratio of the content (a) of the specific compound to the content (b) of the phosphonic acid compound (Content of specific compound/Content of phosphonic acid compound).

In the tables, the column of “a/c” indicates the mass ratio of the content (a) of the specific compound to the content (c) of the basic amino acid (Content of specific compound/Content of basic amino acid).

In the tables, the column of “Dilution ratio” indicates the dilution ratio (volume ratio) of the concentrated solution in a case of preparing the treatment liquid as described above.

In the tables, the numerical value in the column of pH indicates the pH of the treatment liquid at 25° C., which was measured by the above-described pH meter. The above-described pH is a value measured for the treatment liquid prepared by diluting the concentrated solution.

TABLE 1

| | (a) Specific compound | | | (b) Phosphonic | | | (c) Basic amino | | | | | | |
|---|---|---|---|---|---|---|---|---|---|---|---|---|---|
| | | logD | | acid | | | acid | | | Additive | | | Dilution |
| | Type | (pH 7.4) | Amount | Type | Amount | a/b | Type | Amount | a/c | Type | Amount | pH | ratio |
| Example 1 | EEDA | −3.38 | 0.5 | HEDPO | 3.0 | 0.17 | | | | | | 7.4 | 100 |
| Example 2 | EEDA | −3.38 | 0.5 | HEDPO | 3.0 | 0.17 | | | | | | 7.4 | 10 |
| Example 3 | EEDA | −3.38 | 0.5 | HEDPO | 3.0 | 0.17 | | | | | | 7.4 | 1 |
| Example 4 | EEDA | −3.38 | 0.5 | HEDPO | 3.0 | 0.17 | | | | | | 7.4 | 200 |
| Example 5 | EEDA | −3.38 | 0.5 | HEDPO | 3.0 | 0.17 | | | | | | 7.4 | 400 |
| Example 6 | EEDA | −3.38 | 0.5 | EDTMP | 3.0 | 0.17 | | | | | | 7.4 | 100 |
| Example 7 | EEDA | −3.38 | 0.5 | DTPMP | 3.0 | 0.17 | | | | | | 7.4 | 100 |
| Example 8 | EEDA | −3.38 | 0.5 | NMPA | 3.0 | 0.17 | | | | | | 7.4 | 100 |
| Example 9 | EEDA | −3.38 | 0.5 | Phytic | 3.0 | 0.17 | | | | | | 7.4 | 100 |
| | | | | acid | | | | | | | | | |
| Example 10 | EEDA | −3.38 | 0.5 | PBTCA | 3.0 | 0.17 | | | | | | 7.4 | 100 |
| Example 11 | EEDA | −3.38 | 0.5 | IDMP | 3.0 | 0.17 | | | | | | 7.4 | 100 |
| Example 12 | EEDA | −3.38 | 0.5 | EABMP | 3.0 | 0.17 | | | | | | 7.4 | 100 |
| Example 13 | EEDA | −3.38 | 0.5 | MADP | 3.0 | 0.17 | | | | | | 7.4 | 100 |
| Example 14 | EEDA | −3.38 | 0.5 | DAMP | 3.0 | 0.17 | | | | | | 7.4 | 100 |
| Example 15 | EEDA | −3.38 | 0.5 | HMP | 3.0 | 0.17 | | | | | | 7.4 | 100 |
| Example 16 | EEDA | −3.38 | 0.5 | AMPA | 3.0 | 0.17 | | | | | | 7.4 | 100 |
| Example 17 | EEDA | −3.38 | 0.5 | MP | 3.0 | 0.17 | | | | | | 7.4 | 100 |
| Example 18 | EEDA | −3.38 | 0.5 | HEDPO | 3.0 | 0.17 | Arginine | 0.5 | 1.0 | | | 7.4 | 100 |
| Example 19 | EEDA | −3.38 | 0.5 | HEDPO | 3.0 | 0.17 | Histidine | 0.5 | 1.0 | | | 7.4 | 100 |
| Example 20 | EEDA | −3.38 | 0.5 | HEDPO | 3.0 | 0.17 | Lysine | 0.5 | 1.0 | | | 7.4 | 100 |
| Example 21 | EEDA | −3.38 | 0.5 | HEDPO | 3.0 | 0.17 | Arginine | 0.04 | 12.5 | | | 7.4 | 100 |
| Example 22 | EEDA | −3.38 | 0.5 | HEDPO | 3.0 | 0.17 | Arginine | 3.0 | 0.17 | | | 7.4 | 100 |
| Example 23 | EEDA | −3.38 | 0.5 | HEDPO | 3.0 | 0.17 | Arginine | 0.5 | 1.0 | | | 10.0 | 100 |
| Example 24 | EEDA | −3.38 | 0.5 | HEDPO | 3.0 | 0.17 | Arginine | 0.5 | 1.0 | | | 9.0 | 100 |
| Example 25 | EEDA | −3.38 | 0.5 | HEDPO | 3.0 | 0.17 | Arginine | 0.5 | 1.0 | | | 8.0 | 100 |
| Example 26 | EEDA | −3.38 | 0.5 | HEDPO | 3.0 | 0.17 | Arginine | 0.5 | 1.0 | | | 6.0 | 100 |
| Example 27 | EEDA | −3.38 | 0.5 | HEDPO | 3.0 | 0.17 | Arginine | 0.5 | 1.0 | | | 5.0 | 100 |
| Example 28 | EEDA | −3.38 | 0.5 | HEDPO | 3.0 | 0.17 | Arginine | 0.5 | 1.0 | | | 3.0 | 100 |
| Example 29 | EEDA | −3.38 | 0.5 | HEDPO | 3.0 | 0.17 | Arginine | 0.5 | 1.0 | | | 2.5 | 100 |
| Example 30 | EEDA | −3.38 | 0.5 | HEDPO | 3.0 | 0.17 | Arginine | 0.5 | 1.0 | β-CD | 2.8 | 7.4 | 100 |
| Example 31 | EEDA | −3.38 | 0.5 | HEDPO | 3.0 | 0.17 | Arginine | 0.5 | 1.0 | β-CD | 2.8 | 7.4 | 100 |
| | | | | | | | | | | Polyacrylic | 0.5 | | |
| | | | | | | | | | | acid | | | |
| Example 32 | EEDA | −3.38 | 0.01 | HEDPO | 3.0 | 0.003 | | | | | | 7.4 | 100 |
| Example 33 | EEDA | −3.38 | 5.0 | HEDPO | 3.0 | 1.67 | | | | | | 7.4 | 100 |
| Example 34 | EEDA | −3.38 | 0.5 | HEDPO | 0.1 | 5.00 | | | | | | 7.4 | 100 |
| Example 35 | EEDA | −3.38 | 0.5 | HEDPO | 0.04 | 12.50 | | | | | | 7.4 | 100 |
| Example 36 | EEDA | −3.38 | 0.5 | HEDPO | 25.0 | 0.02 | | | | | | 7.4 | 100 |
| Example 37 | 12PDA | −3.88 | 0.5 | HEDPO | 3.0 | 0.17 | | | | | | 7.4 | 100 |
| Example 38 | 13PDA | −5.10 | 0.5 | HEDPO | 3.0 | 0.17 | | | | | | 7.4 | 100 |
| Example 39 | 13DAP | −5.10 | 0.5 | HEDPO | 3.0 | 0.17 | | | | | | 7.4 | 100 |
| Example 40 | 3APDEA | −3.81 | 0.5 | HEDPO | 3.0 | 0.17 | | | | | | 7.4 | 100 |
| Example 41 | B2AEA | −5.62 | 0.5 | HEDPO | 3.0 | 0.17 | | | | | | 7.4 | 100 |
| Example 42 | BAPA | −5.66 | 0.5 | HEDPO | 3.0 | 0.17 | | | | | | 7.4 | 100 |
| Example 43 | TK2HEEDA | −1.92 | 0.5 | HEDPO | 3.0 | 0.17 | | | | | | 7.4 | 100 |
| Example 44 | 3DBAPA | −1.01 | 0.5 | HEDPO | 3.0 | 0.17 | | | | | | 7.4 | 100 |
| Example 45 | BAPEDA | −6.25 | 0.5 | HEDPO | 3.0 | 0.17 | | | | | | 7.4 | 100 |
| Example 46 | T3APA | −6.65 | 0.5 | HEDPO | 3.0 | 0.17 | | | | | | 7.4 | 100 |
| Example 47 | PMDETA | −1.82 | 0.5 | HEDPO | 3.0 | 0.17 | | | | | | 7.4 | 100 |
| Example 48 | T2AEA | −7.13 | 0.5 | HEDPO | 3.0 | 0.17 | | | | | | 7.4 | 100 |
| Example 49 | HMTEEA | −1.99 | 0.5 | HEDPO | 3.0 | 0.17 | | | | | | 7.4 | 100 |
| Example 50 | EDA | −4.16 | 0.5 | HEDPO | 3.0 | 0.17 | | | | | | 7.4 | 100 |
| Comparative | EDA | −4.16 | 0.5 | | | | | | | | | 7.4 | 100 |
| Example 1 | | | | | | | | | | | | | |
| Comparative | Polyethyl- | −14.23 | 0.5 | | | | | | | | | 7.4 | 100 |
| Example 2 | eneimine | | | | | | | | | | | | |
| Comparative | EDA | −4.16 | 2.5 | HEDPO | 0.1 | 25.00 | | | | | | 7.4 | 100 |
| Example 3 | | | | | | | | | | | | | |
| Comparative | EDA | −4.16 | 0.01 | HEDPO | 25.0 | 0.0004 | | | | | | 7.4 | 100 |
| Example 4 | | | | | | | | | | | | | |
| Comparative | | | | HEDPO | 3.0 | | | | | | | 7.4 | 100 |
| Example 5 | | | | | | | | | | | | | |

TABLE 2

| | Evaluation | | |
|---|---|---|---|
| | Organic residue | W corrosion | Iron oxide |
| | removability | inhibition properties | residue removability |
| Example 1 | B | B | B |
| Example 2 | B | B | B |
| Example 3 | B | C | B |
| Example 4 | B | B | B |
| Example 5 | C | B | C |
| Example 6 | B | B | B |
| Example 7 | B | B | B |
| Example 8 | B | B | B |
| Example 9 | B | B | B |
| Example 10 | B | B | B |
| Example 11 | B | B | B |
| Example 12 | B | B | B |
| Example 13 | B | B | B |
| Example 14 | B | B | B |
| Example 15 | B | B | B |
| Example 16 | B | B | B |
| Example 17 | B | B | B |
| Example 18 | B | A | B |
| Example 19 | B | A | B |
| Example 20 | B | A | B |
| Example 21 | B | B | B |
| Example 22 | C | A | C |
| Example 23 | A | D | A |
| Example 24 | B | C | B |
| Example 25 | B | A | B |
| Example 26 | B | A | B |
| Example 27 | B | A | B |
| Example 28 | C | A | B |
| Example 29 | D | A | A |
| Example 30 | A | A | B |
| Example 31 | A | A | B |
| Example 32 | C | C | B |
| Example 33 | B | C | C |
| Example 34 | B | C | C |
| Example 35 | B | C | D |
| Example 36 | B | C | B |
| Example 37 | B | B | B |
| Example 38 | B | B | B |
| Example 39 | B | B | B |
| Example 40 | B | B | B |
| Example 41 | B | B | B |
| Example 42 | B | B | B |
| Example 43 | C | B | B |
| Example 44 | C | B | B |
| Example 45 | C | C | D |
| Example 46 | C | C | D |
| Example 47 | C | D | D |
| Example 48 | C | C | D |
| Example 49 | D | D | D |
| Example 50 | C | D | D |
| Comparative | C | E | E |
| Example 1 | | | |
| Comparative | E | B | E |
| Example 2 | | | |
| Comparative | C | E | E |
| Example 3 | | | |
| Comparative | E | D | C |
| Example 4 | | | |
| Comparative | E | C | D |
| Example 5 | | | |

TABLE 3

| | (a) Specific compound | | | | | | | | | | |
|---|---|---|---|---|---|---|---|---|---|---|---|
| | | logD | | (b) Phosphonic acid | | | (c) Basic amino acid | | | (d) Antibacterial agent | |
| | Type | (pH 7.4) | Amount | Type | Amount | a/b | Type | Amount | a/c | Type | Amount |
| Example 51 | EEDA | −3.38 | 0.5 | HEDPO | 3.0 | 0.17 | Arginine | 0.5 | 1.0 | Sorbic acid | 0.05 |
| Example 52 | EEDA | −3.38 | 0.5 | HEDPO | 3.0 | 0.17 | Arginine | 0.5 | 1.0 | Sorbic acid | 0.05 |
| Example 53 | EEDA | −3.38 | 0.5 | HEDPO | 3.0 | 0.17 | Arginine | 0.5 | 1.0 | Sorbic acid | 0.05 |
| Example 54 | EEDA | −3.38 | 0.5 | HEDPO | 3.0 | 0.17 | Arginine | 0.5 | 1.0 | Sorbic acid | 0.05 |
| Example 55 | EEDA | −3.38 | 0.5 | HEDPO | 3.0 | 0.17 | Arginine | 0.5 | 1.0 | Sorbic acid | 0.05 |
| Example 56 | EEDA | −3.38 | 0.5 | HEDPO | 3.0 | 0.17 | Arginine | 0.5 | 1.0 | MIT | 0.05 |
| Example 57 | EEDA | −3.38 | 0.5 | HEDPO | 3.0 | 0.17 | Arginine | 0.5 | 1.0 | MIT | 0.05 |
| Example 58 | EEDA | −3.38 | 0.5 | HEDPO | 3.0 | 0.17 | Arginine | 0.5 | 1.0 | MIT | 0.05 |
| Example 59 | EEDA | −3.38 | 0.5 | HEDPO | 3.0 | 0.17 | Arginine | 0.5 | 1.0 | MIT | 0.05 |
| Example 60 | EEDA | −3.38 | 0.5 | HEDPO | 3.0 | 0.17 | Arginine | 0.5 | 1.0 | MIT | 0.05 |
| Example 61 | EEDA | −3.38 | 0.5 | HEDPO | 3.0 | 0.17 | Arginine | 0.5 | 1.0 | MIT | 0.041 |
| | | | | | | | | | | OIT | 0.009 |
| Example 62 | EEDA | −3.38 | 0.5 | HEDPO | 3.0 | 0.17 | Arginine | 0.5 | 1.0 | Benzoic acid | 0.05 |
| Example 63 | EEDA | −3.38 | 0.5 | HEDPO | 3.0 | 0.17 | Arginine | 0.5 | 1.0 | Benzethonium | 0.05 |
| | | | | | | | | | | chloride | |
| Example 64 | EEDA | −3.38 | 0.5 | HEDPO | 3.0 | 0.17 | Arginine | 0.5 | 1.0 | Dehydroacetic | 0.05 |
| | | | | | | | | | | acid | |
| Example 65 | EEDA | −3.38 | 0.5 | HEDPO | 3.0 | 0.17 | Arginine | 0.5 | 1.0 | Cresol | 0.05 |
| Example 66 | EEDA | −3.38 | 0.5 | HEDPO | 3.0 | 0.17 | Arginine | 0.5 | 1.0 | Salicylic acid | 0.05 |
| Example 67 | EEDA | −3.38 | 0.5 | HEDPO | 3.0 | 0.17 | Arginine | 0.5 | 1.0 | Salicylic acid | 0.05 |
| Example 68 | EEDA | −3.38 | 0.5 | HEDPO | 3.0 | 0.17 | Arginine | 0.5 | 1.0 | BIT | 0.05 |
| Example 69 | EEDA | −3.38 | 0.5 | HEDPO | 3.0 | 0.17 | Arginine | 0.5 | 1.0 | Benzoic acid | 0.05 |
| Example 70 | EEDA | −3.38 | 0.5 | HEDPO | 3.0 | 0.17 | Histidine | 0.5 | 1.0 | Benzethonium | 0.05 |
| | | | | | | | | | | chloride | |
| Example 71 | EEDA | −3.38 | 0.5 | HEDPO | 3.0 | 0.17 | Histidine | 0.5 | 1.0 | Dehydroacetic | 0.05 |
| | | | | | | | | | | acid | |
| Example 72 | EEDA | −3.38 | 0.5 | HEDPO | 3.0 | 0.17 | Arginine | 0.5 | 1.0 | Cresol | 0.05 |
| Example 73 | EEDA | −3.38 | 0.5 | HEDPO | 3.0 | 0.17 | Histidine | 0.5 | 1.0 | Salicylic acid | 0.05 |
| Example 74 | EEDA | −3.38 | 0.5 | HEDPO | 3.0 | 0.17 | Lysine | 0.5 | 1.0 | Salicylic acid | 0.05 |
| Example 75 | EEDA | −3.38 | 0.5 | HEDPO | 3.0 | 0.17 | Lysine | 0.5 | 1.0 | MIT | 0.05 |
| Example 76 | EEDA | −3.38 | 0.5 | HEDPO | 3.0 | 0.17 | Lysine | 0.5 | 1.0 | MIT | 0.041 |
| | | | | | | | | | | OIT | 0.009 |
| Example 77 | EEDA | −3.38 | 0.5 | HEDPO | 3.0 | 0.17 | Histidine | 0.5 | 1.0 | Benzoic acid | 0.05 |
| Example 78 | EEDA | −3.38 | 0.5 | HEDPO | 3.0 | 0.17 | Arginine | 0.5 | 1.0 | Benzethonium | 0.05 |
| | | | | | | | | | | chloride | |
| Example 79 | EEDA | −3.38 | 0.5 | HEDPO | 3.0 | 0.17 | Histidine | 0.5 | 1.0 | Dehydroacetic | 0.05 |
| | | | | | | | | | | acid | |
| Example 80 | EEDA | −3.38 | 0.5 | HEDPO | 3.0 | 0.17 | Arginine | 0.5 | 1.0 | Cresol | 0.05 |
| Example 81 | EEDA | −3.38 | 0.5 | HEDPO | 3.0 | 0.17 | Histidine | 0.5 | 1.0 | Salicylic acid | 0.05 |
| Example 82 | EEDA | −3.38 | 0.5 | HEDPO | 3.0 | 0.17 | Lysine | 0.5 | 1.0 | Salicylic acid | 0.05 |
| Example 83 | EEDA | −3.38 | 0.5 | HEDPO | 3.0 | 0.17 | Histidine | 0.5 | 1.0 | BIT | 0.05 |

TABLE 4

| | | | | | | | Evaluation | | |
|---|---|---|---|---|---|---|---|---|---|
| | | | | | | | Organic | W corrosion | Iron oxide |
| | (e) Organic acid | | Additive | | | Dilution | residue | inhibition | residue |
| | Type | Amount | Type | Amount | pH | ratio | removability | properties | removability |
| Example 51 | Tartaric acid | 0.4 | Polyacrylic acid | 0.5 | 7.4 | 100 | A | A | A |
| Example 52 | Citric acid | 0.4 | Polyacrylic acid | 0.5 | 7.4 | 100 | A | A | A |
| Example 53 | Malonic acid | 0.4 | Polyacrylic acid | 0.5 | 7.4 | 100 | A | A | A |
| Example 54 | Succinic acid | 0.4 | Polyacrylic acid | 0.5 | 7.4 | 100 | A | A | A |
| Example 55 | Malic acid | 0.4 | Polyacrylic acid | 0.5 | 7.4 | 100 | A | A | A |
| Example 56 | Tartaric acid | 0.4 | Polyacrylic acid | 0.5 | 7.4 | 100 | A | A | A |
| Example 57 | Citric acid | 0.4 | Polyacrylic acid | 0.5 | 7.4 | 100 | A | A | A |
| Example 58 | Malonic acid | 0.4 | Polyacrylic acid | 0.5 | 7.4 | 100 | A | A | A |
| Example 59 | Succinic acid | 0.4 | Polyacrylic acid | 0.5 | 7.4 | 100 | A | A | A |
| Example 60 | Malic acid | 0.4 | Polyacrylic acid | 0.5 | 7.4 | 100 | A | A | A |
| Example 61 | Citric acid | 0.4 | Polyacrylic acid | 0.5 | 7.4 | 100 | A | A | A |
| Example 62 | Citric acid | 0.4 | Polyacrylic acid | 0.5 | 7.4 | 100 | A | A | A |
| Example 63 | Citric acid | 0.4 | Polyacrylic acid | 0.5 | 7.4 | 100 | A | A | A |
| Example 64 | Citric acid | 0.4 | Polyacrylic acid | 0.5 | 7.4 | 100 | A | A | A |
| Example 65 | Citric acid | 0.4 | Polyacrylic acid | 0.5 | 7.4 | 100 | A | A | A |
| Example 66 | Citric acid | 0.4 | Polysulfonic acid | 0.5 | 7.4 | 100 | A | A | A |
| Example 67 | Malic acid | 0.4 | Polyacrylic acid | 0.5 | 7.4 | 100 | A | A | A |
| Example 68 | Citric acid | 0.4 | Polyacrylic acid | 0.5 | 7.4 | 100 | A | A | A |
| Example 69 | Citric acid | 0.4 | Acrylic acid-sulfonic | 0.5 | 7.4 | 100 | A | B | A |
| | | | acid copolymer | | | | | | |
| Example 70 | Citric acid | 0.4 | Acrylic acid-sulfonic | 0.5 | 7.4 | 100 | A | B | A |
| | | | acid copolymer | | | | | | |
| Example 71 | Malic acid | 0.4 | Acrylic acid-sulfonic | 0.5 | 7.4 | 100 | A | B | A |
| | | | acid copolymer | | | | | | |
| Example 72 | Citric acid | 0.4 | Acrylic acid-sulfonic | 0.5 | 7.4 | 100 | A | B | A |
| | | | acid copolymer | | | | | | |
| Example 73 | Tartaric acid | 0.4 | Acrylic acid-sulfonic | 0.5 | 7.4 | 100 | A | B | A |
| | | | acid copolymer | | | | | | |
| Example 74 | Malic acid | 0.4 | Acrylic acid-sulfonic | 0.5 | 7.4 | 100 | A | B | A |
| | | | acid copolymer | | | | | | |
| Example 75 | Malic acid | 0.4 | Polyacrylic acid | 0.5 | 10.0 | 100 | A | D | A |
| Example 76 | Citric acid | 0.4 | Polyacrylic acid | 0.5 | 9.0 | 100 | B | C | B |
| Example 77 | Citric acid | 0.4 | Polysulfonic acid | 0.5 | 8.0 | 100 | A | A | B |
| Example 78 | Citric acid | 0.4 | Polysulfonic acid | 0.5 | 6.0 | 100 | B | A | B |
| Example 79 | Citric acid | 0.4 | Polysulfonic acid | 0.5 | 5.0 | 100 | B | A | B |
| Example 80 | Citric acid | 0.4 | Polysulfonic acid | 0.5 | 3.0 | 100 | C | A | B |
| Example 81 | Citric acid | 0.4 | Polyacrylic acid | 0.5 | 2.5 | 100 | D | A | A |
| Example 82 | Malic acid | 0.4 | Polyacrylic acid | 0.5 | 7.4 | 100 | A | A | A |
| Example 83 | Citric acid | 0.4 | Polyacrylic acid | 0.5 | 7.4 | 100 | A | A | A |

From the results of the above tables, it was found that the treatment liquid according to the embodiment of the present invention could suppress the corrosion of tungsten or molybdenum, had excellent organic residue removability, and further had excellent iron oxide residue removability.

On the other hand, from the results of Comparative Examples, it was found that the treatment liquid not satisfying the requirements of the present invention did not satisfy at least one of the corrosion inhibition of tungsten or molybdenum, the organic residue removability, or the iron oxide residue removability at a desired level.

From the comparison of Examples 1 to 5 and Examples 32 and 33, it was found that, in a case where the content of the specific compound was 0.002% by mass or more with respect to the total mass of the treatment liquid, the organic residue removability was more excellent; and in a case where the content of the specific compound was 0.1% by mass or less, the corrosion inhibition properties were more excellent.

From the comparison of Examples 1 to 5 and Examples 33 to 36, it was found that, in a case where the content of the phosphonic acid compound was 0.01% by mass or more with respect to the total mass of the treatment liquid, the iron oxide residue removability was more excellent.

From the comparison of Examples 21 and 22 with Example 18, it was found that, in a case where the mass ratio of the content of the specific compound to the content of the basic amino acid was 0.2 or more, the organic residue removability and the iron oxide residue removability were more excellent; and in a case where the mass ratio was 10.0 or less, the corrosion inhibition properties were more excellent.

From the comparison of Examples 18 and 22 to 29, it was confirmed that, in a case where the pH was 3.0 or more, the organic residue removability and the iron oxide residue removability were more excellent; in a case where the pH was 5.0 or more, the organic residue removability was still more excellent; in a case where the pH was 9.0 or less, the corrosion inhibition properties were more excellent; and in a case where the pH was 8.0 or less, the corrosion inhibition properties were still more excellent.

From the comparison of Examples 18 to 20 with Examples 30 and 31, it was found that, in a case where the treatment liquid contained cyclodextrin or the cyclodextrin derivative, the organic residue removability was more excellent.

From the comparison of Examples 1 and 32 to 36, it was found that, in a case where the mass ratio of the content of the specific compound to the content of the phosphonic acid compound was 0.01 or more, the organic residue removability was more excellent; in a case where the mass ratio was 0.1 or more, the corrosion inhibition properties were more excellent; in a case where the mass ratio was 10.0 or less, the iron oxide residue removability was more excellent; and in a case where the mass ratio was 1.0 or less, the iron oxide residue removability was still more excellent.

From the comparison of Examples 37 to 50, it was found that, in a case where the log D value of the specific compound at a pH of 7.4 was −6.0 or more, the effect of the present invention was more excellent; and in a case where the log D value was −2.0 or less, the organic residue removability was more excellent.

From the comparison of Examples 37 to 50, it was found that, in a case where the number of nitrogen atoms in the specific compound was 2 or 3, the effect of the present invention was more excellent.

From the comparison of Examples 37 to 50, it was found that, in a case where the number of carbon atoms in the specific compound was 3 to 11, the organic residue removability was more excellent; and in a case where the number of carbon atoms was 3 to 9, the organic residue removability was still more excellent.

From the comparison of Examples 1 and 2 with Examples 51 to 68, it was found that, in a case where the treatment liquid contained the low-molecular-weight organic acid different from the phosphonic acid compound, the iron oxide residue removability was more excellent.

From the comparison of Examples 69 to 74 with Examples 51 to 68, it was found that, in a case where the anionic polymer was polyacrylic acid, the corrosion inhibition properties were more excellent.

From the comparison of Examples 75 to 82, it was found that, in a case where the pH was 9.0 or less, the corrosion inhibition properties were more excellent; and in a case where the pH was 8.0 or less, the corrosion inhibition properties were still more excellent. In addition, it was found that, in a case where the pH was 3.0 or more, the organic residue removability was more excellent; in a case where the pH was 5.0 or more, the organic residue removability was still more excellent; and in a case where the pH was 7.0 or more, the organic residue removability was particularly excellent.

### [Evaluation 2]

Organic residue removability in a system subjected to buff cleaning was evaluated according to the following procedure.

Concentrated chemical liquids 1 to 12, which were each an aqueous solution containing 10% by mass of Tween-20 (manufactured by FUJIFILM Wako Pure Chemical Corporation) and having a pH of 1.6, 2, 2.5, 3, 3.5, 4, 5, 6, 7, 8, 8.4, or 9, were prepared. A concentrated chemical liquid 13 containing 10% by mass of Tween-20, 3.0% by mass of HEDPO, and having a pH of 3 was prepared. The pH of the chemical liquids 1 to 8 was adjusted using nitric acid, and the pH of the chemical liquids 9 to 13 was adjusted using Tris.

Concentrated chemical liquids 14 and 15, which were each an aqueous solution containing 10% by mass of Tween-40 (manufactured by FUJIFILM Wako Pure Chemical Corporation) and having a pH of 1.6 or 3, were prepared. A concentrated chemical liquid 16, which was an aqueous solution containing 10% by mass of Tween-40, 0.05% by mass of MIT, and having a pH of 8, was prepared. The pH of the chemical liquids 14 and 15 was adjusted using nitric acid, and the pH of the chemical liquid 16 was adjusted using Tris.

Concentrated chemical liquids 17 and 18, which were each an aqueous solution containing 10% by mass of Tween-60 (manufactured by FUJIFILM Wako Pure Chemical Corporation) and having a pH of 3 or 8, were prepared. The pH of the chemical liquid 17 was adjusted using nitric acid, and the pH of the chemical liquid 18 was adjusted using Tris.

Concentrated chemical liquids 19 and 20, which were each an aqueous solution containing 10% by mass of Tween-80 (manufactured by FUJIFILM Wako Pure Chemical Corporation) and having a pH of 1.6 or 7, were prepared. A concentrated chemical liquid 21, which was an aqueous solution containing 10% by mass of Tween-80, 0.05% by mass of MIT, and having a pH of 8.4, was prepared. The pH of the chemical liquid 19 was adjusted using nitric acid, and the pH of the chemical liquids 20 and 21 was adjusted using Tris.

Concentrated chemical liquids 22 to 24, which were each an aqueous solution containing 0.3% by mass, 1% by mass, or 3% by mass of Tween-20, 0.05% by mass of MIT, and having a pH of 7, were prepared. The pH of the chemical liquids 22 to 24 was adjusted using Tris.

DIW was used as water in the above-described concentrated chemical liquids.

The above-described concentrated chemical liquids 1 to 24 were diluted 10 times with DIW to prepare chemical liquids 1 to 24.

### [Organic Residue Removability]

A wafer subjected to a CMP treatment was prepared according to the procedure described in [Evaluation 1] of [Organic residue removability] above.

Next, using FREX300S-II (polishing device, manufactured by EBARA CORPORATION), the obtained wafer subjected to the CMP treatment (diameter: 12 inches) was buff-cleaned using the prepared chemical liquid 1 under conditions of a pressure of 0.5 psi (35 hPa), a chemical liquid supply rate of 0.28 mL/(min·cm²), and a treatment time of 20 seconds.

Thereafter, the obtained wafer subjected to the CMP treatment and the buff cleaning treatment was subjected to scrub cleaning for 60 seconds using the treatment liquid of Example 28, adjusted to room temperature (23° C.), washed with deionized water for 30 seconds, and then subjected to a drying treatment.

As a result of performing the evaluation according to the procedure described in [Evaluation 1] of [Organic residue removability] above, it was found that the evaluation of the organic residue removability was improved by one stage, and a more excellent result was obtained.

In addition, in a case where each of the chemical liquids 2 to 23 was used instead of the chemical liquid 1, and in a case where the treatment liquid of Examples or Comparative Examples was used instead of the treatment liquid of Example 28, the same results were obtained.

Furthermore, even in a case where the conditions of the buff cleaning treatment described above were changed to a pressure of 0.1 to 4 psi, a chemical liquid supply rate of 0.07 to 0.56 mL/(min·cm²), and a treatment time of 5 to 60 seconds, the same results were obtained.

From the above results, it was found that, by performing the buff cleaning treatment using the above-described chemical liquid, the organic residue removability could be improved in various treatment liquids and buff cleaning conditions.

What is claimed is:

1. A treatment liquid comprising:
a specific compound represented by Formula (1); and
at least one phosphonic acid compound selected from the group consisting of phosphonic acid and an organic phosphonic acid,
wherein a mass ratio of a content of the specific compound to a content of the phosphonic acid compound is 0.001 to 20.0, 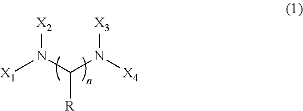
in Formula (1), X₁ to X₄ and R each independently represent a hydrogen atom or an aliphatic hydrocarbon group which may have a hydroxyl group or an amino group, a plurality of R's may be the same or different from each other, a plurality of R's may be bonded to each other to form a ring, and
n is an integer of 2 or more.

2. The treatment liquid according to claim 1,
wherein a log D value of the specific compound at a pH of 7.4 is −7.2 to −1.0.

3. The treatment liquid according to claim 1,
wherein a pH is 3.0 to 9.0.

4. The treatment liquid according to claim 1, further comprising:
at least one basic amino acid selected from the group consisting of arginine, histidine, and lysine.

5. The treatment liquid according to claim 1, further comprising:
cyclodextrin or a cyclodextrin derivative.

6. The treatment liquid according to claim 4,
wherein a mass ratio of the content of the specific compound to a content of the basic amino acid is 0.2 to 10.0.

7. The treatment liquid according to claim 1,
wherein the specific compound contains 2 or 3 nitrogen atoms.

8. The treatment liquid according to claim 1,
wherein the specific compound contains 3 to 11 carbon atoms.

9. The treatment liquid according to claim 1, further comprising:
an antibacterial agent.

10. The treatment liquid according to claim 1, further comprising:
an anionic polymer.

11. The treatment liquid according to claim 1, further comprising:
a low-molecular-weight organic acid different from the phosphonic acid compound.

12. A treatment method for an object to be treated, comprising:
a step of bringing an object to be treated containing at least one of tungsten or molybdenum, which has been subjected to a chemical mechanical polishing treatment, into contact with the treatment liquid according to claim 1.

13. A treatment method for a pad, comprising:
a step of bringing a pad used for chemical mechanical polishing into contact with the treatment liquid according to any one of claim 1.

14. A manufacturing method of an electronic device, comprising:
the treatment method for an object to be treated according to claim 12.

15. The treatment liquid according to claim 2,
wherein a pH is 3.0 to 9.0.

16. The treatment liquid according to claim 2, further comprising:
at least one basic amino acid selected from the group consisting of arginine, histidine, and lysine.

17. The treatment liquid according to claim 2, further comprising:
cyclodextrin or a cyclodextrin derivative.

18. The treatment liquid according to claim 16,
wherein a mass ratio of the content of the specific compound to a content of the basic amino acid is 0.2 to 10.0.

19. The treatment liquid according to claim 2,
wherein the specific compound contains 2 or 3 nitrogen atoms.

20. The treatment liquid according to claim 2,
wherein the specific compound contains 3 to 11 carbon atoms.
